(19) United States
(12) Patent Application Publication
(10) Pub. No.: US 2011/0043893 A1
(43) Pub. Date: Feb. 24, 2011

(54) EVALUATION METHOD, DISPLAY SHEET MANUFACTURING METHOD AND DISPLAY SHEET MANUFACTURING APPARATUS

(75) Inventors: Satoshi OGAWA, Shiojiri-shi (JP); Yuji Misawa, Takatsuki-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, TOKYO (JP)

(21) Appl. No.: 12/845,993

(22) Filed: Jul. 29, 2010

(30) Foreign Application Priority Data
Aug. 20, 2009 (JP) 2009-191458

(51) Int. Cl. G02F 1/167; H01J 9/24

(52) U.S. Cl. 359/296; 445/24

(57) ABSTRACT

An evaluation method that evaluates display characteristic of a display sheet equipped with a display layer having a plurality of microcapsules containing positively or negatively charged electrophoretic particles, includes: applying a voltage across a pair of first electrode and second electrode disposed opposite each other across the display layer, to apply an electric field to an examination region set in at least a portion of the area of the display layer.

This application claims priority to Japanese patent application No. 2009-191458 filed Aug. 20, 2009, and the said application is herein incorporated in the present specification.

### BACKGROUND

1. Technical Field

The present invention relates to evaluation methods, methods for manufacturing display sheets, and apparatuses for manufacturing display sheets.

2. Related Art

Electrophoretic displays that use electrophoresis of particles, which composes, for example, an image display section of an electronic paper, are known (see, for example, JP-A-2007-58151 (Patent Document 1)). Electrophoretic displays have excellent portability and power-saving property, and thus particularly suitable as image display sections of electronic paper. Patent Document 1 describes an electrophoretic display device (a display sheet) having a pair of oppositely disposed electrodes and a display layer that is provided between these electrodes and equipped with a plurality of microcapsules enclosing dispersion liquid in which electrophoretic particles are dispersed therein. The electrophoretic display device described in Patent Document 1 is structured such that, upon application of voltage across the pair of electrodes to exert electric fields on the microcapsules, the electrophoretic particles are moved by electrophoresis within the microcapsules, whereby the display color being displayed on the display surface is switched.

If, in the electrophoretic display device of Patent Document 1, the microcapsules within the display layer have mutually equal particle sizes, and are located at the same position with respect to one another in the thickness direction of the display layer, uneven distribution states of the electrophoretic particles within each of the microcapsules become to be generally the same when an equal voltage is applied between each of the pixel electrodes and the common electrode for the same length of time. As a result, a single color without irregularity can be displayed entirely over the display surface.

However, if the plurality of microcapsules included in the display layer have mutually different particle sizes, and the locations of the plurality of microcapsules included in the display layer are mutually different in the thickness direction of the display layer, uneven distribution states of the electrophoretic particles within each of the microcapsules do not become to be generally the same even when an equal voltage is applied between each of the pixel electrodes and the common electrode for the same length of time. As a result, an image with irregularity would be displayed on the display surface. In other words, according to the image display device described in Patent Document 1, deterioration of the display characteristic (display performance) originating from differences in the particle sizes of the microcapsules and the positions of the microcapsules may occur. For example, when such image display devices are mass-manufactured, the plurality of image display devices would have different degrees of deterioration in the display characteristic.

### SUMMARY

In accordance with an advantage of some aspects of the invention, it is possible to provide an evaluation method that enables easy evaluation of the display characteristic of a display sheet, a display sheet manufacturing method that is capable of efficiently manufacturing display sheets having display characteristics above a predetermined level through incorporation of the evaluation method, and a manufacturing apparatus that is capable of readily evaluating the display characteristic of a display sheet.

An evaluation method in accordance with an embodiment of the invention pertains to an evaluation method that evaluates the display characteristic of a display sheet equipped with a display layer having a plurality of microcapsules containing positively or negatively charged electrophoretic particles. The evaluation method includes applying a voltage across a pair of first electrode and second electrode disposed opposite each other across the display layer, to apply an electric field to an examination region set in at least a portion of the area of the display layer, and detecting the presence of an improper portion whose display state is improper, which may be caused by at least one of a difference in particle size among the microcapsules and a difference in floating level of the microcapsules, through detecting a color difference in the improper portion against a proper portion whose display state is proper. By detecting such an improper portion in this manner, the display characteristic of the display sheet can be readily evaluated.

According to the evaluation method in an aspect of the embodiment of the invention, the display sheet may have the display layer and a common electrode provided on one surface side of the display layer in a manner to enclose the plurality of microcapsules, wherein the common electrode also serves as the first electrode, and the presence of an improper portion may preferably be detected from the side of the second electrode. As a result, the display characteristic of the display layer formed on the display sheet can be evaluated by using a portion of the display sheet that is an evaluation target, such that the evaluation can be more readily performed.

In the evaluation method in accordance with an aspect of the invention, the electrophoretic particles may include positively charged particles that are positively charged and negatively charged particles that are negatively charged and in a different color from the positively charged particles, and the display sheet may preferably be capable of displaying a first display color with the positively charged particles locally gathered on the side of the second electrode, a second display color with the negatively charged particles locally gathered on the side of the second electrode, and a third display color that is a halftone between the first display color and the second display color.

In the evaluation method in accordance with an aspect of the invention, the voltage that causes the third display color is applied between the first electrode and the second electrode, and a portion of the first display color or the second display color may preferably be specified as the improper portion. As a result, the display characteristic of the display layer can be readily evaluated. Also, this clearly defines an evaluation reference, such that equal evaluation can be made among individual display layers.

In the evaluation method in accordance with an aspect of the invention, the voltage may preferably be applied between the first electrode and the second electrode such that the positively charged particles move toward the first electrode and the negatively charged particles move toward the second electrode. This can readily make the display layer to be the third display color.

In the evaluation method in accordance with an aspect of the invention, the voltage may preferably be an alternate voltage that alternately repeats a voltage drop and a voltage elevation in which the voltage elevation takes a shorter time than a time required for the voltage drop. By using such a voltage, the positively and negatively charged particles can be smoothly moved by electrophoresis.

In the evaluation method in accordance with an aspect of the invention, a portion in the first display color may preferably be specified as a portion that includes the microcapsule having a particle size smaller than the particle size of the microcapsule included in the proper portion. Such a judgment method makes it possible to evaluate the display characteristic of the display layer in more detail.

In the evaluation method in accordance with an aspect of the invention, a portion in the second display color may preferably be specified as a portion that includes the microcapsule that floats more toward the second electrode than the microcapsules included in the proper portion, or a portion that includes the microcapsule having a particle size greater than the particle size of the microcapsule included in the proper portion. Such a judgment method makes it possible to evaluate the display characteristic of the display layer in more detail.

In the evaluation method in accordance with an aspect of the invention, prior to application of the voltage, a preliminary voltage that causes the first display color may preferably be applied between the first electrode and the second electrode. As a result, the display characteristic of the display layer can be more accurately evaluated.

In the evaluation method in accordance with an aspect of the invention, the voltage may preferably be applied between the first electrode and the second electrode such that the positively charged particles move toward the second electrode, and the negatively charged particles move toward the first electrode. Accordingly, the display layer can be readily set in the third display color.

In the evaluation method in accordance with an aspect of the invention, the voltage may preferably be an alternate voltage that alternately repeats a voltage elevation and a voltage drop that takes a shorter time than a time required for the voltage elevation. By using such a voltage, the positively and negatively charged particles can be smoothly moved by electrophoresis.

In the evaluation method in accordance with an aspect of the invention, a portion in the second display color may preferably be specified as a portion that includes the microcapsule having a particle size smaller than the particle size of the microcapsule included in the proper portion. Such a judgment method makes it possible to evaluate the display characteristic of the display layer in more detail.

In the evaluation method in accordance with an aspect of the invention, a portion in the first display color may preferably be specified as a portion that includes the microcapsule that floats more toward the second electrode than the microcapsules included in the proper portion, or a portion that includes the microcapsule having a particle size greater than the particle size of the microcapsule included in the proper portion. Such a judgment method makes it possible to evaluate the display characteristic of the display layer in more detail.

In the evaluation method in accordance with an aspect of the invention, prior to application of the voltage, a preliminary voltage that causes the second display color may preferably be applied between the first electrode and the second electrode. As a result, the display characteristic of the display layer can be more accurately evaluated.

In the evaluation method in accordance with an aspect of the invention, the voltage may preferably be applied without contacting the second electrode with the display layer. As a result, damage to the display layer that may be caused by the contact with the second electrode can be reliably prevented.

In the evaluation method in accordance with an aspect of the invention, the second electrode may preferably be provided to extend in a first direction as viewed in a plan view of the display layer, wherein the voltage may preferably be applied while moving the electrode relative to the display layer in a second direction orthogonal to the first direction. By this, the second electrode can be made smaller in size. Therefore, it is possible to prevent or suppress generation of uneven voltage distribution along various portions of the second electrode, whereby uniform electric fields can be more reliably applied across the entire area of the display layer.

In the evaluation method in accordance with an aspect of the invention, the second electrode may preferably protrude toward the display layer, and may preferably have a plurality of needle-like portions arranged in the first direction. As a result, lines of electric force are collected at the tip of each of the needle-like sections, whereby electric fields can be effectively generated between the first electrode and the second electrode.

In the evaluation method in accordance with an aspect of the invention, the presence of the improper portion may preferably be detected by using an imaging element. As a result, clear image data on the display layer can be obtained.

A display sheet manufacturing method in accordance with an embodiment of the invention pertains to a method for manufacturing a display sheet equipped with a plurality of microcapsules containing positively charged or negatively charged electrophoretic particles in a moveable manner. The display sheet manufacturing method includes: a forming step of forming the display layer; and an evaluation step including applying a voltage across a pair of first electrode and second electrode disposed opposite each other across the display layer, to apply an electric field to an examination region set in at least a portion of the area of the display layer, and detecting the presence of an improper portion whose display state is improper, which may be caused by at least one of a difference in particle size among the microcapsules and a difference in floating level of the microcapsules, through detecting a color difference in the improper portion against a proper portion whose display state is proper. As a result, the display sheet can be fabricated with display characteristics above a predetermined level.

A display sheet manufacturing apparatus in accordance with an embodiment of the invention pertains to a display sheet manufacturing apparatus for manufacturing a display sheet by forming a display layer on a sheet member. The display sheet manufacturing apparatus includes a display layer forming device that forms the display layer on one surface side of the sheet member, and an evaluation device that evaluates display characteristics of the display layer, wherein the evaluation device includes: at least one electrode; a voltage application device that applies a voltage to the electrode; and a transfer device that moves a display sheet equipped with a display layer having a plurality of microcapsules containing positively charged or negatively charged electrophoretic particles in a moveable manner, relative to the electrode, wherein, while moving the display layer relative to the electrode by the transfer device, a voltage is applied to the electrode by the voltage application device, thereby exerting an electric field to an examination region set in at least a portion of the area of the display layer, whereby the presence of an improper portion whose display state is improper, which may be caused by at least one of a difference in particle size among the microcapsules and a difference in floating level of the microcapsules may be detected through detecting a color difference in the improper portion with respect to a proper portion whose display state is proper. By this, while manufacturing a display sheet, the display characteristic of the display layer can be evaluated, such that the display sheet with display characteristics above a predetermined level can be effectively fabricated.

### BRIEF DESCRIPTION OF THE DRAWINGS

FIG. 1 is a cross-sectional view of a display device fabricated by a manufacturing method in accordance with a first embodiment of the invention.

FIG. 2 is a cross-sectional view showing a state of driving the display device shown in FIG. 1.

FIG. 3 is a cross-sectional view showing a state of driving the display device shown in FIG. 1.

FIG. 4 is a cross-sectional view showing a state of driving the display device shown in FIG. 1.

FIG. 5 is a schematic diagram of a manufacturing apparatus that manufactures the display device shown in FIG. 1.

FIG. 6 is a perspective view showing a display layer forming section of the manufacturing apparatus shown in FIG. 5.

FIG. 7 is a perspective view showing a first voltage application section of the manufacturing apparatus shown in FIG. 5.

FIG. 8 is a perspective view showing a second voltage application section of the manufacturing apparatus shown in FIG. 5.

FIG. 9 is a perspective view showing an imaging/evaluation section of the manufacturing apparatus shown in FIG. 5.

FIGS. 10A and 10B are perspective views showing a discriminating section of the manufacturing apparatus shown in FIG. 5.

FIG. 11 is a cross-sectional view of a sheet member.

FIG. 12 is a view for explaining a method for forming a display layer.

FIG. 13 is a cross-sectional view of a display layer.

FIGS. 14A and 14B are plan views of display layers.

FIGS. 15A and 15B show patterns of voltages applied to an electrode of the first voltage application section.

FIG. 16 is an equivalent circuit diagram between a common electrode of the sheet member and an application electrode of the first voltage application section.

FIG. 17 is a cross-sectional view showing a state of the display layer after treatment by the first voltage application section.

FIGS. 18A and 18B show patterns of voltages applied to an electrode of the second voltage application section.

FIG. 19 is a top plan view showing a state of the display layer after treatment by the second voltage application section.

FIGS. 20A and 20B show patterns of voltages applied to an electrode of the first voltage application section.

FIG. 21 is a cross-sectional view showing a state of the display layer after treatment by the first voltage application section.

FIGS. 22A and 22B show patterns of voltages to be applied to an electrode of the second voltage application section.

### DESCRIPTION OF EXEMPLARY EMBODIMENTS

Preferred embodiments of an evaluation method, a display sheet manufacturing method and a display sheet manufacturing apparatus are described in detail below with reference to the accompanying drawings.

### First Embodiment

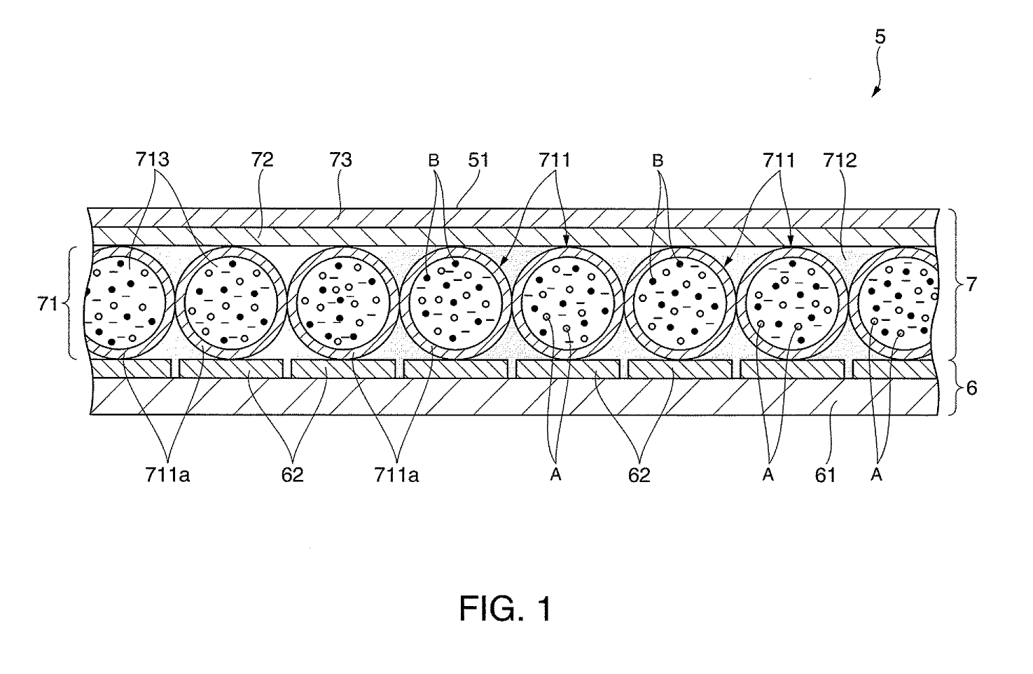

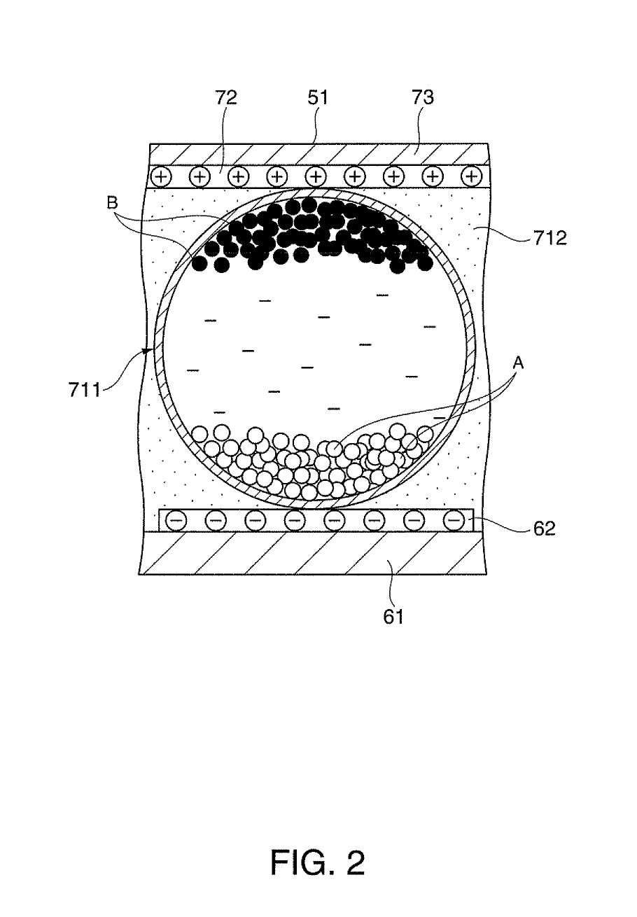

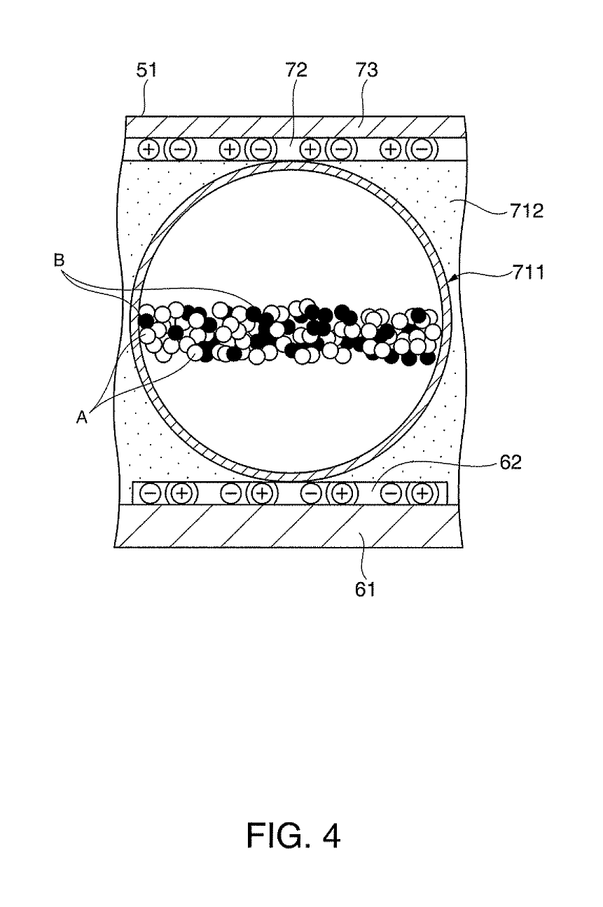

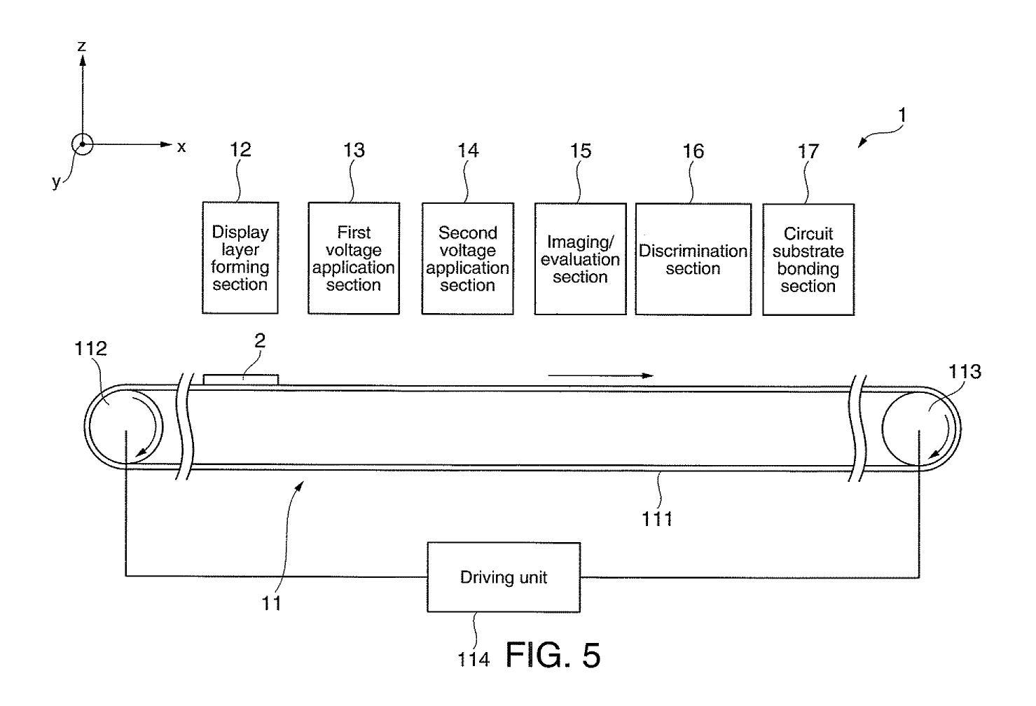

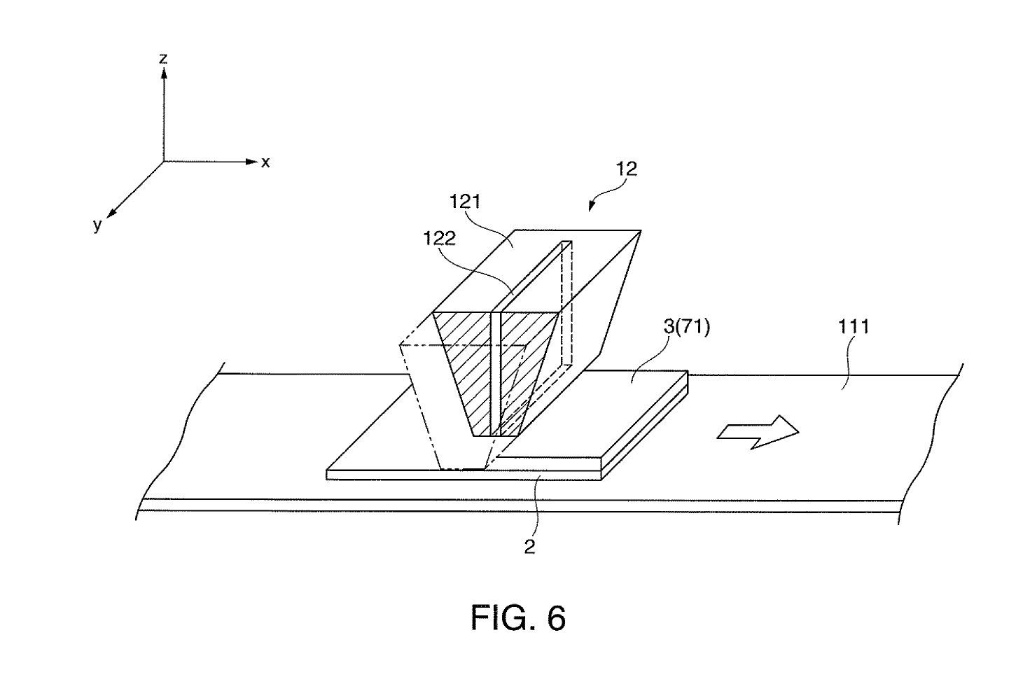

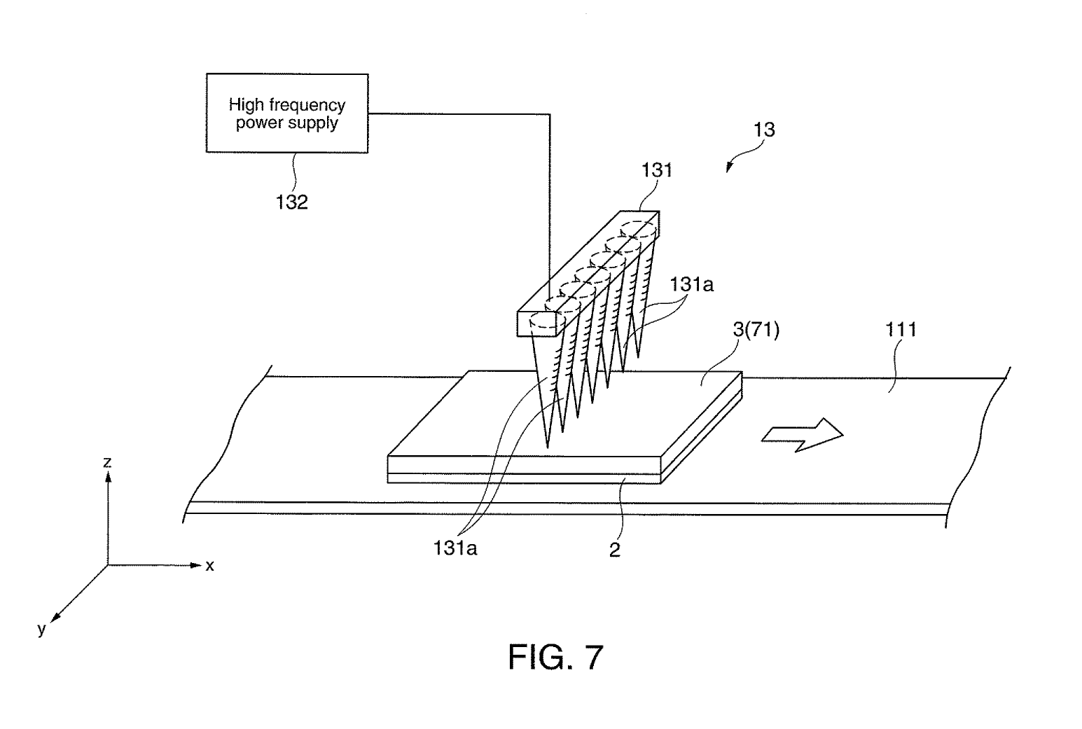

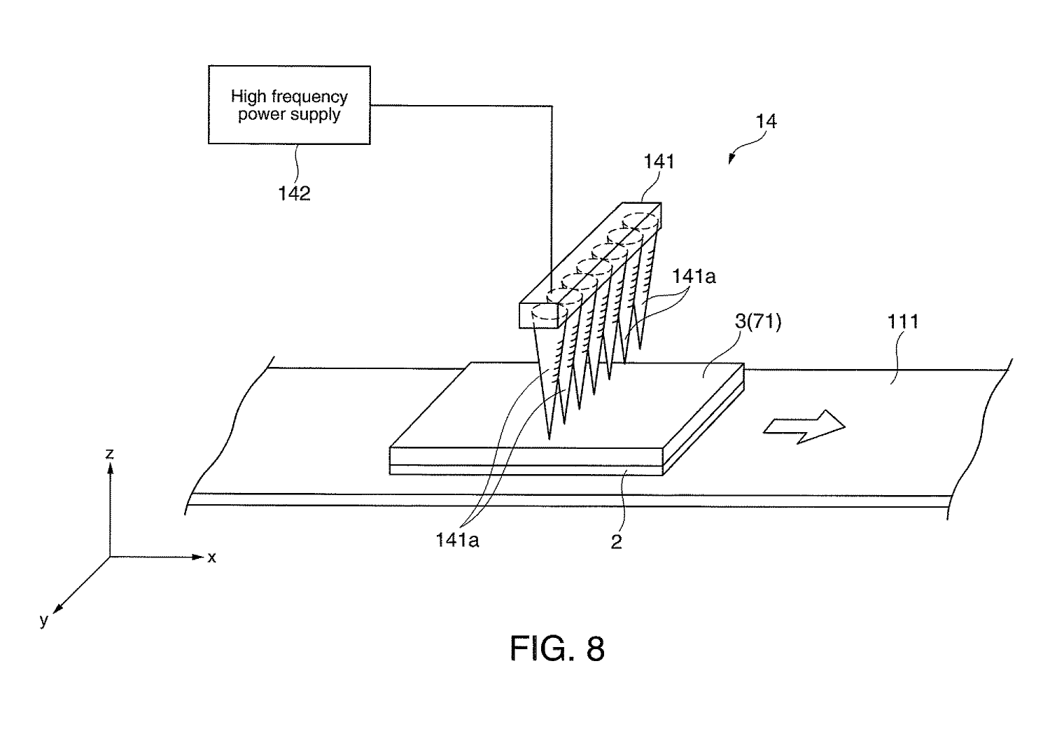

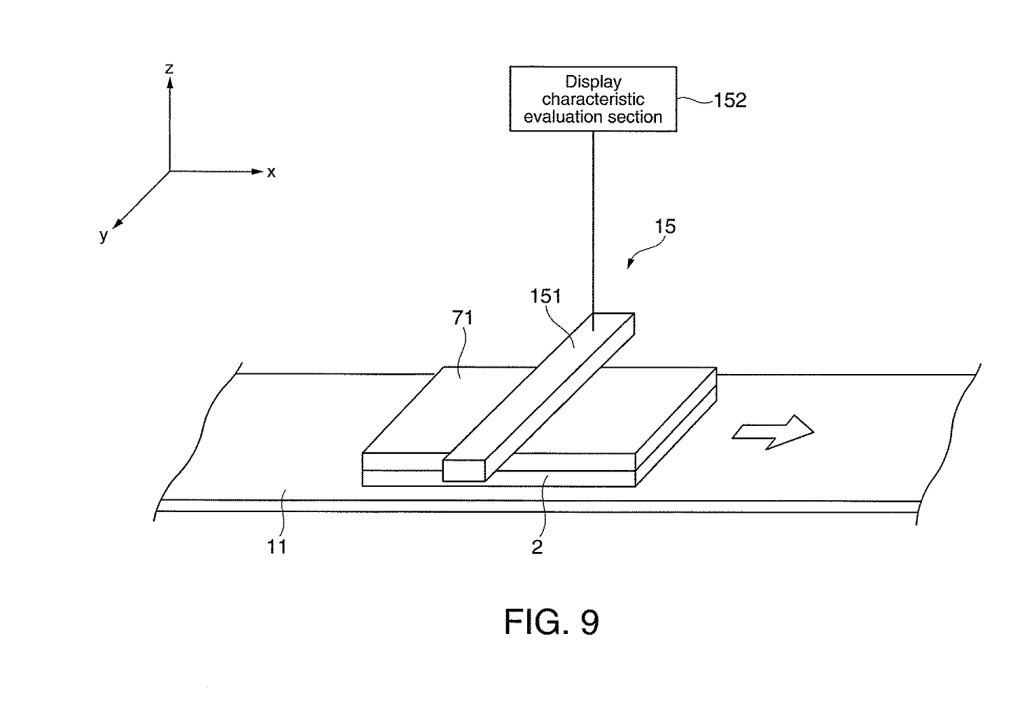

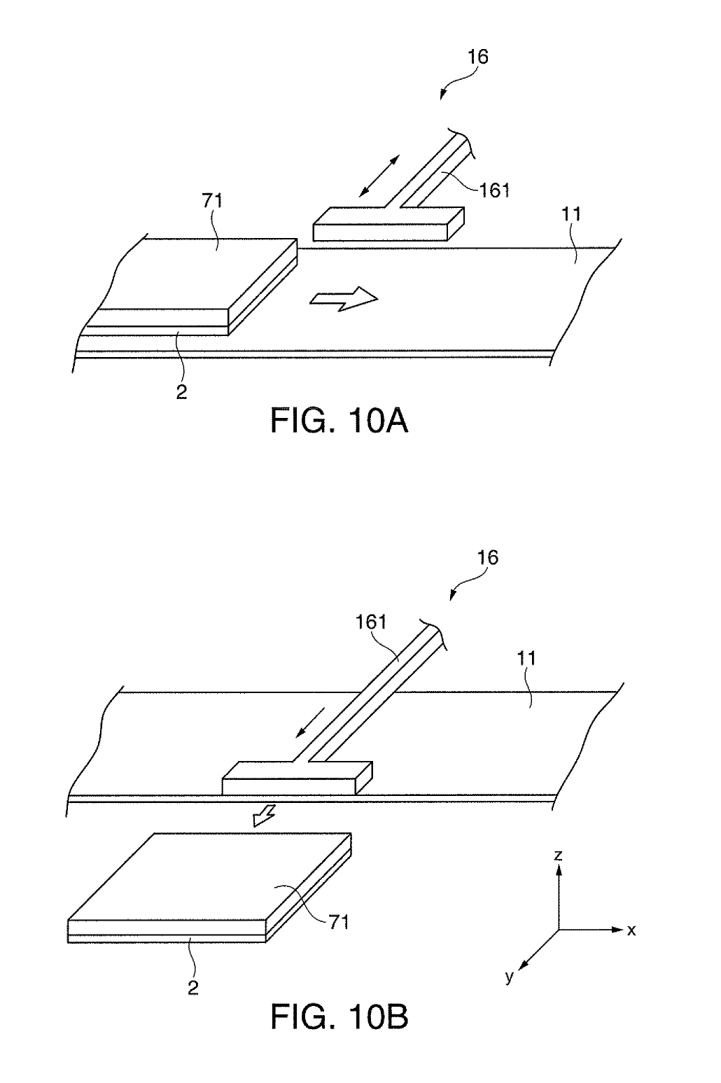

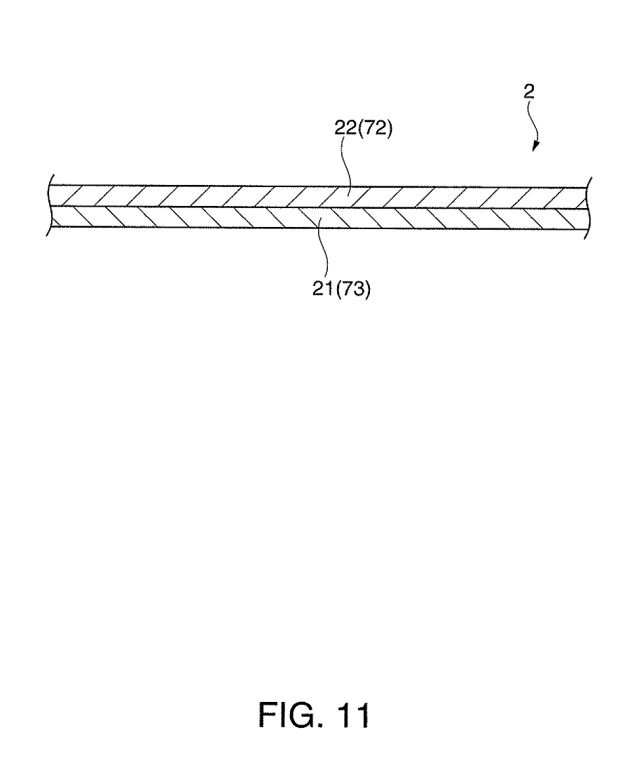

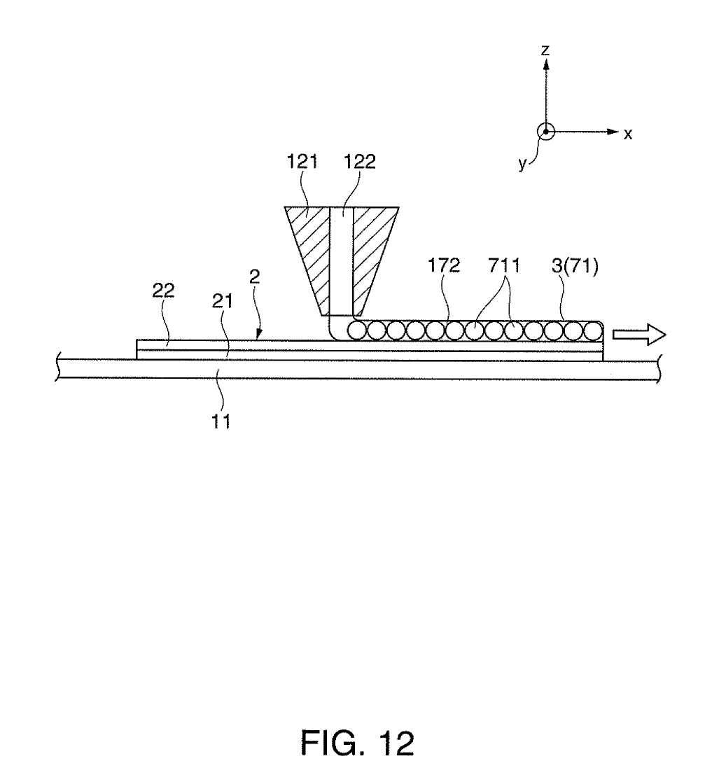

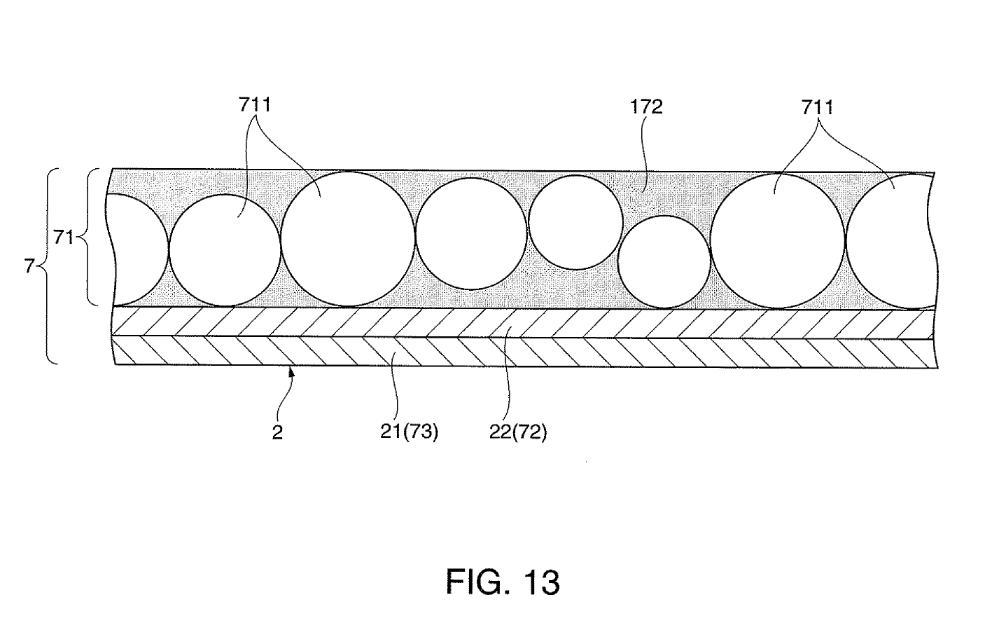

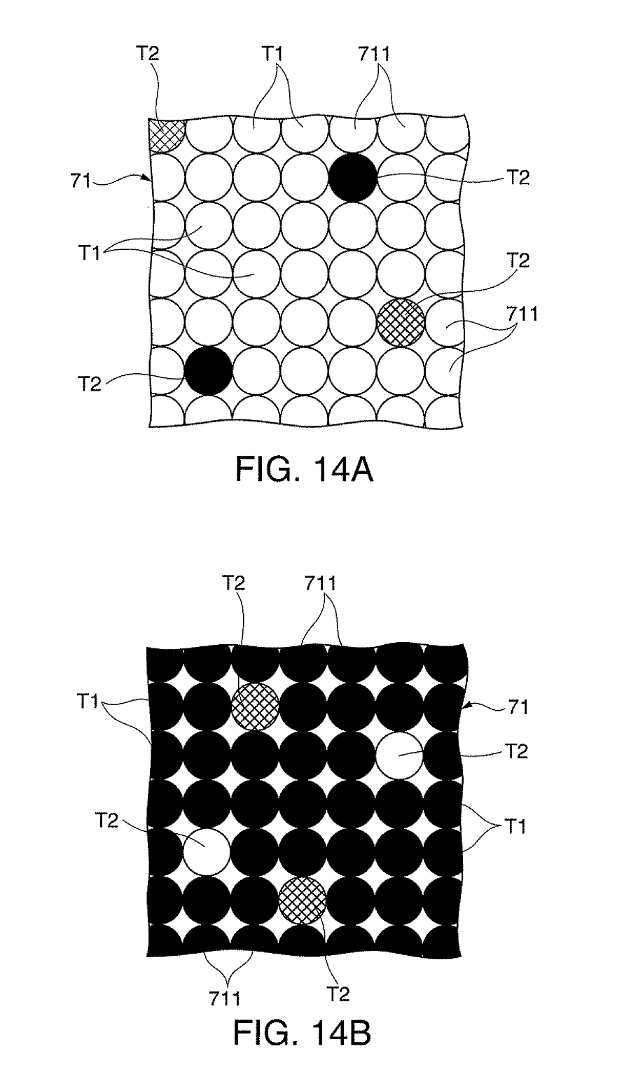

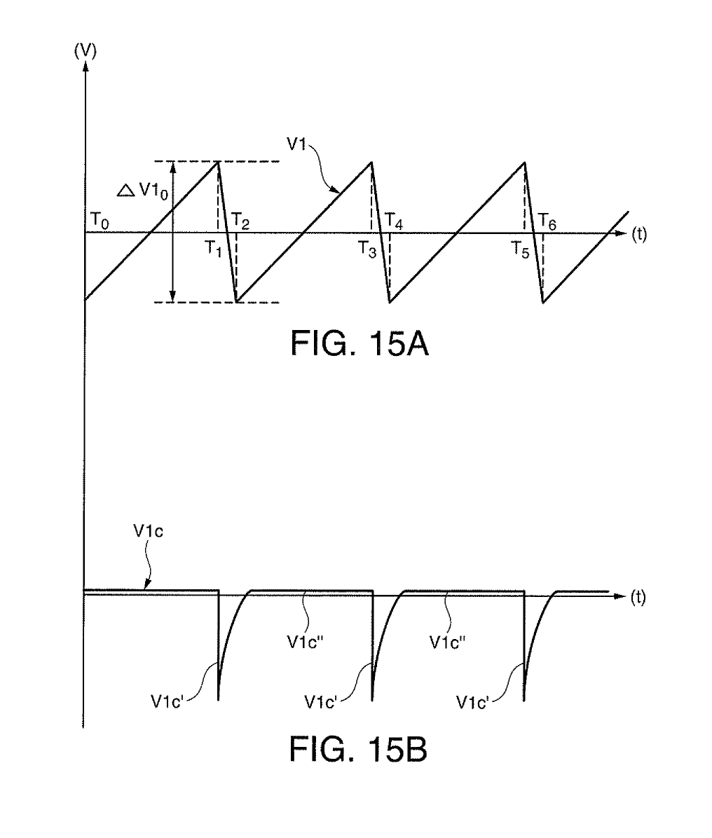

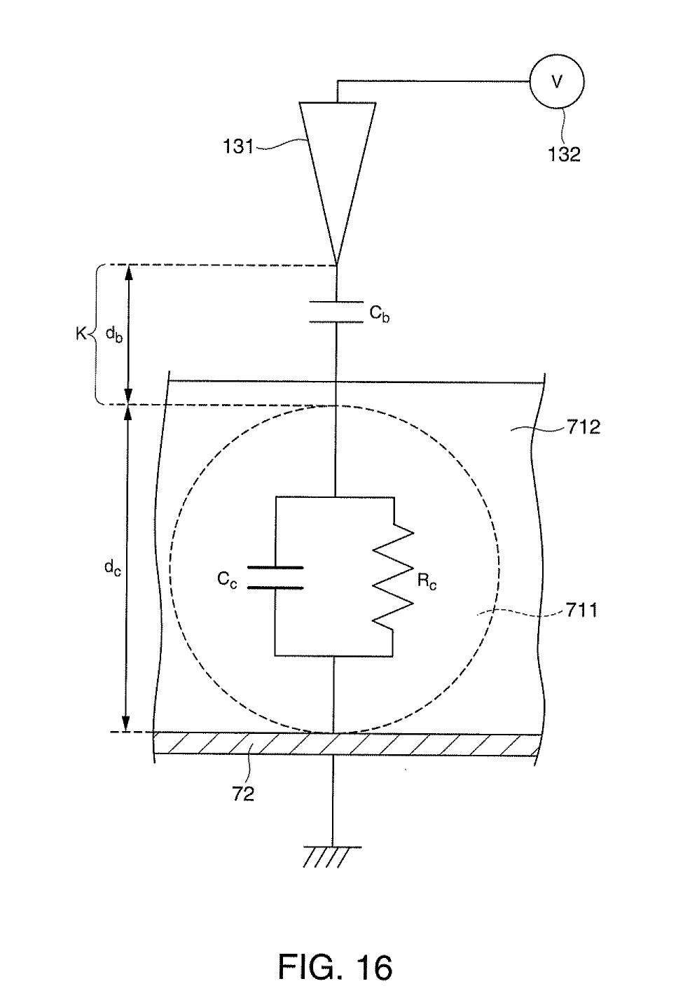

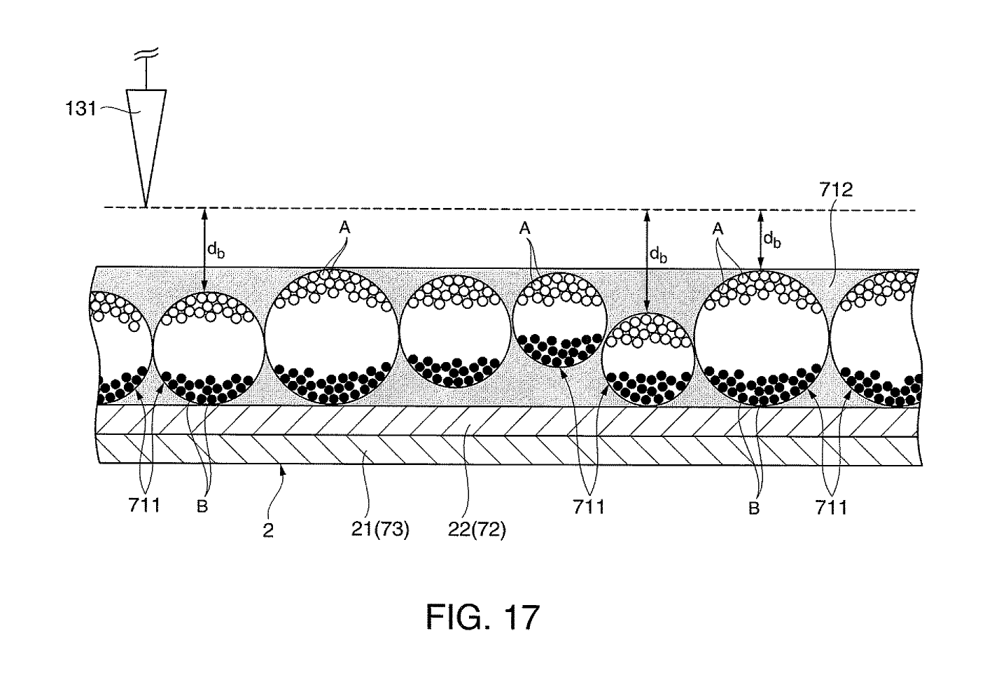

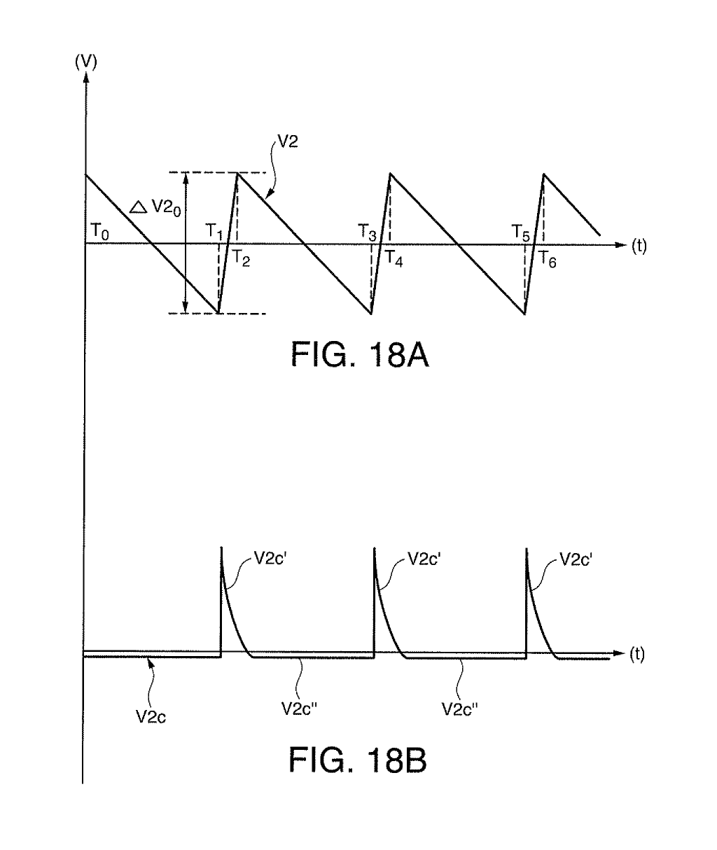

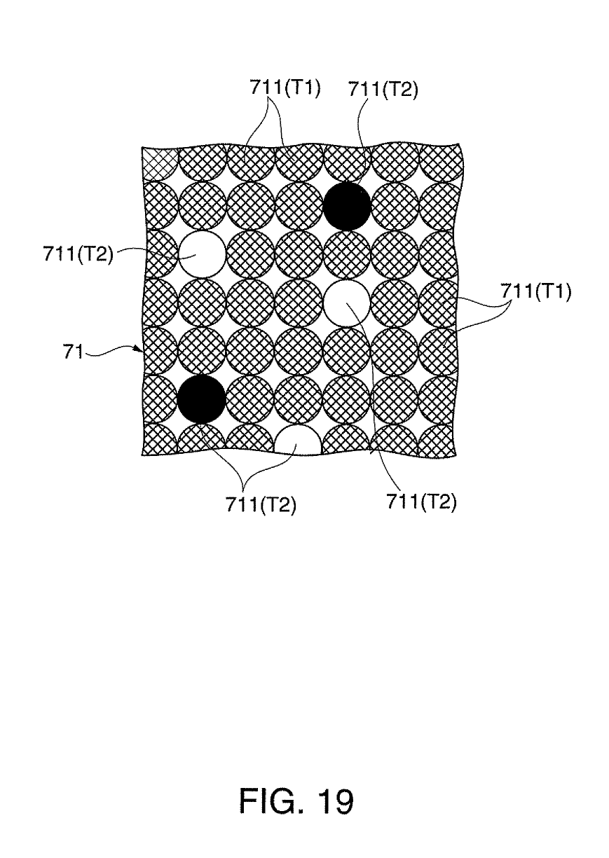

First, an evaluation method, a display sheet manufacturing method and a display sheet manufacturing apparatus (a manufacturing apparatus of an embodiment of the invention) in accordance with a first embodiment of the invention are described. FIG. 1 is a cross-sectional view of a display device fabricated by a manufacturing method in accordance with the first embodiment of the invention. FIGS. 2-4 are cross-sectional views respectively showing states of driving the display device shown in FIG. 1. FIG. 5 is a schematic diagram of a manufacturing apparatus that manufactures the display device shown in FIG. 1. FIG. 6 is a perspective view showing a display layer forming section of the manufacturing apparatus shown in FIG. 5. FIG. 7 is a perspective view showing a first voltage application section of the manufacturing apparatus shown in FIG. 5. FIG. 8 is a perspective view showing a second voltage application section of the manufacturing apparatus shown in FIG. 5. FIG. 9 is a perspective view showing an imaging/evaluation section of the manufacturing apparatus shown in FIG. 5. FIGS. 10A and 10B are perspective views showing a discriminating section of the manufacturing apparatus shown in FIG. 5. FIG. 11 is a cross-sectional view of a sheet member. FIG. 12 is a view for explaining a method for forming a display layer. FIG. 13 is a cross-sectional view of a display layer. FIGS. 14A and 14B are plan views of display layers. FIGS. 15A and 15B show patterns of voltages to be applied to an electrode of the first voltage application section. FIG. 16 is an equivalent circuit diagram between a common electrode of the sheet member and an application electrode of the first voltage application section. FIG. 17 is a cross-sectional view showing a state of the display layer after treatment by the first voltage application section. FIGS. 18A and 18B show patterns of voltages to be applied to an electrode of the second voltage application section. FIG. 19 is a top plan view showing a state of the display layer after treatment by the second voltage application section. It is noted that, in the following description, the upper side in FIGS. 1-13 and FIG. 17 is defined as “up” and the lower side is defined as “down” for the sake of convenience of the description. Also, as shown in FIG. 1, three axes that are orthogonal to each other are defined as an x-axis, a y-axis and a z-axis, respectively. Also, a transfer direction of a sheet member lies in the x-axis, and an axis that is orthogonal to the x-axis in a plan view of the sheet member is the y-axis.

Display Device 5

First, a display device 5 that is manufactured by a manufacturing apparatus (a manufacturing apparatus in accordance with an embodiment of the invention) 1 is described. The display device 5 is an electrophoretic display device that displays an image, using electrophoresis of electrophoretic particles. As shown in FIG. 1, the display device 5 includes a circuit substrate (a backplane) 6, a display sheet 7 bonded to an upper surface of the circuit substrate 6, and a voltage application device 8 that applies voltages between pixel electrodes 62 provided on the circuit substrate 6 to be described below and a common electrode 72 provided on the display sheet 7 to be described below.

The circuit substrate 6 includes a planar base section 61, a plurality of pixel electrodes 62 provided in a matrix configuration on an upper surface of the base section 61, and a circuit including switching elements such as TFTs (not shown) provided to correspond to the respective pixel electrodes 62. With the circuit substrate 6 having such a structure, the switching elements are independently ON/OFF controlled, whereby the pixel electrodes 62 to which voltages are to be applied by the voltage application device 8 can be freely selected. It is noted that base section 61 may be made of a flexible or rigid material, but may preferably be made of a flexible material. By using the base substrate 61 having flexibility, the display device 5 having flexibility can be obtained. As a result, the usefulness of the display device 5 is improved.

The display sheet 7 includes a display layer 71 provided on an upper surface of the circuit substrate 6, a common electrode 72 provided on the upper surface of the display layer 71, and a protective sheet 73 provided on the upper surface of the common electrode 72. In this display sheet 7 (i.e., the display device 5), the upper surface of the protective sheet 73 composes a display surface 51. Specified images can be recognized as the display layer 71 is viewed through the display surface 51. The display layer 71 is structured with a plurality of microcapsules 711 fixed (retained) therein by binder 712. Also, the plurality of microcapsules 711 are arranged laterally between the circuit substrate 6 and the common electrode 72 in a single layer (arranged side by side without overlapping in the thickness direction).

Each of the microcapsules 711 has a spherical capsule body (a shell body) 711a, and electrophoretic dispersion liquid filled inside thereof (in an inner space thereof). Because each of the microcapsules 711 has a spherical shape, each of the microcapsules 711 can exhibit excellent pressure-resistant property and bleed resistance property. Accordingly, even when external force is applied to the display layer when the display sheet 7 is bent or pressed, each of the microcapsules 711 can alleviate and absorb the external force. Accordingly, destruction of each of the microcapsules 711 can be effectively prevented.

As a constituent material of the capsule body 711a, for example, gelatin, a composite material of gum Arabic and gelatin, and various kinds of resin materials such as urethane-based resin, melamine-based resin, urea-based resin, epoxy-based resin, phenol-based resin, acryl-based resin, urethane-based resin, olefin-based resin, polyimide, polyether, and the like can be enumerated without any particular limitation to the foregoing materials. One or more of them can be used independently or in combination.

The electrophoretic dispersion liquid filled in the capsule body 711a includes positively charged particles A and negatively charged particles B dispersed (suspended) in a liquid phase dispersion medium 713. A task of dispersing the positively charged particles A and the negatively charged particles B in the dispersion medium 713 may be performed by using one or a combination of two or more of for example, a paint shaker method, a ball mill method, a media mill method, an ultrasonic dispersion method and a stirrer dispersion method.

As the liquid-phase dispersion medium 713, it is possible to use, for example, aromatic hydrocarbons including benzene hydrocarbons; paraffinic hydrocarbons such as n-hexane and n-decane; isoparaffinic hydrocarbons such as ISOPAR (available from Exxon Chemicals); olefin hydrocarbons such as 1-octene and 1-decene; aliphatic hydrocarbons including naphthenic hydrocarbons; carbon hydride series compounds made of petroleum or derived from petroleum such as Kerosene, petroleum ether, petroleum benzine, Ligroin, industrial gasoline and petroleum naphtha; halogen hydrocarbons such as dichloromethane and chloroform; silicone oils (organic silicone oils) such as dimethyl silicone oil and methylphenyl silicone oil; and fluorinated solvent (organic fluorinated solvent) such as hydrofluoroether. Above all, organic silicon oils may preferably be used as their viscosity can be readily adjusted.

The positively charged particles A are electrophoretic particles that are white and positively charged. Also, the negatively charged particles B are electrophoretic particles that are black and negatively charged. By using the white positively charged particles A and the black negatively charged particles B, white and black display can be made by the display device 5, and the display contrast of the display device 5 is improved.

It is noted that, in accordance with the present embodiment, white particles are used as the positively charged particles A, and black particles are used as the negatively charged particles B. However, the positively charged particles A and the negatively charged particles B are not limited to any particular colors, and can be in any colors as long as they are mutually different. For example, these colors can be appropriately selected from among chromatic colors such as red, blue, green and the like, and colors with metallic luster such as gold, silver and the like according to specific purposes. Also the combination of the colors of the positively charged particles A and the negatively charged particles B is not limited to the above described combination. For example, a combination of positively charged black particles A and negatively charged white particles B, a combination of positively charged blue particles A and negatively charged red particles B, and a combination of positively charged gold color particles and negatively charged silver color particles are also possible.

As the positively charged particles A and the negatively charged particles B, any particles can be used as long as they have electrical charges. Although the positively charged particles A and the negatively charged particles B are not particularly limited to any types, at least one type of pigment particles, resin particles and compound particles composed of the aforementioned particles may be favorably used. These particles are advantageous because they can readily be manufactured, and their charge amount control is relatively easy.

As the pigment composing the pigment particles, black pigments such as aniline black, carbon black, titanium black and the like; white pigments such as titanium dioxide, antimony trioxide and the like; azole pigments such as monoazo and the like; yellow pigments such as isoindolinone, chrome yellow and the like; red pigments such as quinacridone red, chrome vermilion and the like; blue pigments such as phthalocyanine blue, indanthrene blue and the like; and green pigments such as phthalocyanine green and the like can be used. One or more of them can be used independently or in combination.

Among the pigment particles described above, titanium oxide particles are preferably used as white particles (the positively charged particles A in the present embodiment), and titanium black particles are preferably used as black particles (the negatively charged particles B in the present embodiment). The aforementioned particles are highly responsive to electric fields, and have a great difference in the reflectance, which enables the display device 5 to perform high contrast display.

Also, as a resin material that composes the resin particles, for examples, acryl-based resin, urethane-based resin, urea-based resin, epoxy-based resin, polystyrene, polyester and the like can be enumerated. One or a combination of two or more of these resin materials may be used. As the composite particles, for example, particles produced by coating surfaces of the pigment particles with the resin material or other pigment; particles produced by coating surfaces of the resin particles with the pigment; and particles made of a mixture obtained by mixing the pigment and the resin material in a suitable composition ratio can be enumerated. As the particles produced by coating surfaces of the pigment particles with other pigment, particles produced by coating titanium oxide particles with silicon oxide or aluminum oxide may be exemplified. Moreover, each of the positively charged particles A and the negatively charged particles B is not particularly limited to any shape, but may preferably be in a spherical shape.

The positively charged particles A and the negatively charged particles B with smaller particle size may preferably be used, in consideration of dispersion property thereof in the liquid phase dispersion medium 713. More specifically, their average particle size may preferably be between about 10 μm and about 500 μm, and more preferably between about 20 μm and about 300 μm. When the average particle size of the positively charged particles A and the negatively charged particles B is in the range described above, aggregation of the positively charged particles A with the negatively charged particles B and sedimentation of the positively charged particles A and the negatively charged particles B can be prevented, and the state in which the positively charged particles A and the negatively charged particles B are kept dispersed in the liquid phase dispersion medium 713 can be maintained. As a result, the display quality of the display device 5 can be favorably prevented from deterioration.

It is noted that, when two types of different electrophoretic particles (i.e., the positively charged particles A and the negatively charged particles B) are used as in the present embodiment, it is preferred to differentiate the average particle sizes of the two types of particles, in particular, it is preferred to set the average particle size of the white positively charged particles A to be greater than the average particle size of the black negatively charged particles B. As a result, the display contrast of the display device 5 can be improved, and its retention property can be improved. More specifically, the average particle size of the black negatively charged particles B may preferably be set between about 20 μm and about 100 μm, and the average particle size of the white positively charged particles A may preferably be set between about 150 μm and about 300 μm. Furthermore, the specific gravity of each of the positively charged particles A and the negatively charged particles B may preferably be set to be equal to the specific gravity of the liquid phase dispersion medium 713. By so doing, the positively charged particles A and the negatively charged particles B can stay at constant positions in the liquid phase dispersion medium 713 for a long time even after having been subjected to the effect of electric fields to be described below.

The binder 712 is supplied, for example, for bonding the circuit substrate 6 and the common electrode 72, affixing each of the microcapsules 711 between the substrate and the electrodes, and the like. By this, durability and reliability of the display device 5 can be improved. As the binder 41, a resin material is preferably used because of its excellent affinity (adhesion) with the circuit substrate 6, the common electrode 72, and the capsule bodies 711a, and excellent insulation property. As the material of the binder 712, various resin materials can be used. For example, urethane based resins, such as, plyacrylonitrile, polyethylene, polypropylene, polyethylene terephthalate, polycarbonate, nylon 66, polyurethane and the like; methacrylate ester resins, such as, epoxide, polyimide, ABS resin, polyvinyl acetate, poly(methyl methacrylate), poly(ethyl methacrylate), poly(butyl methacrylate), poly(octyl methacrylate), and the like; polyvinyl chloride resins; cellulose based resins; silicon based resins, ethylene-vinyl acetate copolymers and the like may be used. One or more of the foregoing resins can be used independently or in combination. The common electrode 72 is provided on the upper surface of the display layer 71 having the structure described above. The common electrode 72 is provided in a manner to cover the entire upper surface of the display layer 71. Also, the common electrode 72 is light-transmissive, in other words, substantially transparent (colorless transparent, colored transparent or translucent).

The common electrode 72 may be made of any material that is substantially transparent and substantially electrically conductive, without any particular limitation. Examples of such a conductive material includes: for example, a metallic material such as copper, aluminum or alloy containing these metals; a carbon-based material such as carbon black; an electronically conductive polymer material such as polyacetylene, polyfluorene or derivatives thereof an ion-conductive polymer material produced by dispersing an ionic substance such as NaCl or Cu(CF₃SO₃)₂ in a matrix resin such as polyvinyl alcohol or polycarbonate; and a conductive oxide material such as indium tin oxide (ITO); and the like. One or more of these materials may be used independently or in combination. Any of the foregoing materials may also be used as a constituent material of the pixel electrodes 62 described above.

The protective sheet 73 is provided on the upper surface of the common electrode 72. The protective sheet 73 is provided, for example, for the purpose of protecting the common electrode 72 and the display layer 71. The protective sheet 73 has a sheet-like configuration and insulation property. Also, the protective sheet 73 is light-transmissive, in other words, substantially transparent (colorless transparent, colored transparent or translucent), as it composes the display surface 51 of the display device 5. As a result, the state of the display layer 71 (i.e., the state of the electrophoretic particles A and B in each of the microcapsules 711), in other words, an image (information) displayed on the display device 5 can be visually recognized from the side of the display surface 51.

It is noted that the protective sheet 73 may be made of flexible material or rigid material, but preferably be made of flexible material. By using the protective sheet 73 having flexibility, the display device 5 having flexibility can be obtained. By this, usefulness of the display device 5 is improved. When the protective sheet 73 is made to have flexibility, polyolefin such as polyethylene, modified polyolefin, polyamide, thermoplastic polyamide, polyether, polyether ether ketone, polyurethane-based, and chlorinated polyethylene-based and other various thermoplastic elastomers, and copolymers, blends or polymer alloys mainly constituted of the aforementioned materials may be used as the constituent material. One or more of these materials may be used independently or in combination. The display device 5 having the structure described above is driven (to display an image) in a manner described below. Because each of the microcapsules 711 has the same structure, one of the microcapsules 711 will be described below as a representative, for the sake of description.

Black Display State

First, the state in which a black color is displayed on the display surface 51 is described. The voltage application device 8 applies a voltage between the common electrode 72 and the pixel electrode 62 to set the common electrode side 72 on a positive potential and the pixel electrode side 62 on a negative potential, thereby generating an electric field with the side of the common electrode 72 being on a positive potential, and the side of the pixel electrode 62 being on a negative potential. As the electric field is exerted on the microcapsule 711, the positively charged particles A move by electrophoresis toward the pixel electrode 62 that is on the negative potential, and the negatively charged particles B move by electrophoresis toward the common electrode 72 that is on the positive potential. By such electrophoretic migration of the positively charged particles A and the negatively charged particles B, as shown in FIG. 2, the positively charged particles A are locally gathered to the side of the pixel electrode 62, and the negatively charged particles B are locally gathered to the side of the common electrode 72. As a result, the color (black color) of the negatively charged particles B is displayed on the display surface 51, thereby creating a black display state.

White Display State

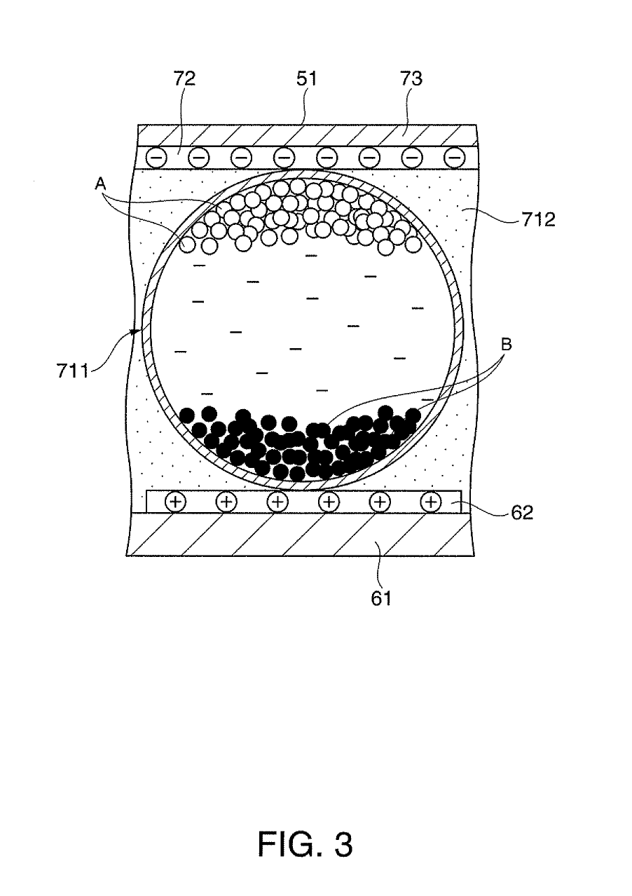

Next, the state in which a white color is displayed on the display surface 51 is described. The voltage application device 8 applies a voltage between the common electrode 72 and the pixel electrode 62 to set the common electrode side 72 on a negative potential and the pixel electrode side 62 on a positive potential, thereby generating an electric field with the side of the common electrode 72 being on a negative potential, and the side of the pixel electrode 62 being on a positive potential. As the electric field is exerted on the microcapsule 711, the negatively charged particles B move by electrophoresis toward the pixel electrode 62 that is on the positive potential and the positively charged particles A move by electrophoresis toward the common electrode 72 that is on the negative potential. By such electrophoretic migration of the positively charged particles A and the negatively charged particles B, as shown in FIG. 3, the negatively charged particles B are locally gathered to the side of the pixel electrode 62, and the positively charged particles A are locally gathered to the side of the common electrode 72. As a result, the color (white color) of the positively charged particles A is displayed on the display surface 51, thereby creating a white display state.

Gray Display State

Next, the state in which a gray color that is a halftone color between white color and black color is displayed on the display surface 51 is described. For example, the display surface 51 is initially in the black display state as described above. Then, the voltage application device 8 applies a voltage between the common electrode 72 and the pixel electrode 62 to set the common electrode side 72 on a negative potential and the pixel electrode side 62 on a positive potential, thereby generating an electric field with the side of the common electrode 72 being on a negative potential, and the side of the pixel electrode 62 being on a positive potential. As the electric field is exerted on the microcapsule 711, the negatively charged particles B move by electrophoresis toward the pixel electrode 62 that is on the positive potential and the positively charged particles A move by electrophoresis toward the common electrode 72 that is on the negative potential. By such electrophoretic migration of the positively charged particles A and the negatively charged particles B, the positively charged particles A and the negatively charged particles B migrate. When they are located at the central area of the microcapsule 711, the voltage application by the voltage application device 8 is stopped. By this operation, the positively and negatively charged particles A and B assume a mixed state in the central area of the microcapsule 711, whereby a gray color that is a halftone color between black color and white color is displayed on the display surface 51, thereby creating a gray display state.

On the other hand, after creating the white display state, the voltage application device 8 may apply a voltage between the common electrode 72 and the pixel electrode 62 to set the common electrode side 72 on a positive potential and the pixel electrode side 62 on a negative potential, and the voltage application by the voltage application device 8 may be stopped when the positively charged particles A and the negatively charged particles B are located in the central area of the microcapsule 711. This operation can also create a gray display state.

With the structure described above, electrophoretic movements of the positively charged particles A (white particles) and the negatively charged particles B (black particles) may be selectively controlled for each of the microcapsules 711, whereby desired information (image) can be displayed on the display surface 51 of the display device 5 based on light reflected on the positively charged particles A and the negatively charged particles B.

Manufacturing Apparatus 1

Next, a manufacturing apparatus 1 that is capable of manufacturing the display device 5 described above, and evaluating the display characteristic of the display layer 71 is described. As shown in FIG. 5, the manufacturing apparatus 1 is equipped with a transfer unit formed from a belt conveyor 11, a display layer forming section (a display layer forming unit) 12, a first voltage application section 13, a second voltage application section 14, an imaging/evaluation section 15, a discriminating section 16, and a circuit substrate bonding section 17. Among the constituting units, the first voltage application section 13, the second voltage application section 14 and the imaging/evaluation section 15 form an evaluation unit for evaluating characteristics of a display layer.

As shown in FIG. 3, the belt conveyor 11 is disposed to extend in an x-axis direction, and transfer a sheet member 2 (to be described below) in the x-axis direction. The belt conveyor 11 includes an endless belt 111, a pair of drive rollers 112 and 113 for rotating the endless belt 111, and a driving unit 114 equipped with, for example, a servo motor or the like for rotating the drive rollers 112 and 113. With the belt conveyor 11, the drive rollers 112 and 113 are rotated by the drive unit 114, thereby rotating the endless belt 111 in one direction (clockwise in FIG. 3) at a constant speed. The display layer forming section 12 is provided above the belt conveyor 11. The display layer forming section 12 has a function to form a display layer 71 on the upper surface of the sheet member 2 that is transferred on the belt conveyor 11.

As shown in FIG. 6, the display layer forming section 12 has a nozzle 121 that extends in a direction (y-axis direction) orthogonal to the x-axis direction (the transfer direction of the sheet member 2), a nozzle aperture 122 that is formed in a manner to penetrate the nozzle 121 and extends in the y-axis direction, and a tank (not shown) communicating with the nozzle aperture 122.

The nozzle aperture 122 is formed in a manner to cover the entire area of the width (the entire area in the y-axis direction) of the sheet member 2. Also, the tank stores a mixed liquid 3 in which a plurality of microcapsules 711 and a binder 712 are mixed. The mixed liquid 3 can be ejected through the nozzle aperture 122. The display layer forming section 12 supplies the mixed liquid 3 through the nozzle aperture 122 onto an upper surface of the sheet member 2 that is transferred to a location below the nozzle 121 by the belt conveyor 11, thereby coating the mixed liquid 3 to form a display layer 71.

It is noted that the method of coating the mixed liquid 3 (coating the microcapsules 711) on the sheet member 2 is not limited to the method described above, and may be performed by any one of other methods, such as, for example, die coat method, wire bar code method, roll coat method, knife coat method, blade coat method, slit coat method, gravure coat method, dip coat method, spin coat method, spray coat method, screen coat method, and screen printing method. Among the aforementioned coating methods, die coat method, roll coat method, knife coat method, blade coat method, slit coat method, gravure coat method and screen printing method are suitable because a uniform coated film (the display layer 71) can be relatively readily obtained when the mixed liquid (coating liquid) 3 containing the microcapsules 711 is coated on the sheet member 2. Further, these coating methods may be conducted by piece-to-piece coating method, or continuously by roll-to-roll coating method. These coating methods can be appropriately selected according to the requirement.

The first voltage application section 13 is provided above the belt conveyor 11, in front (the downstream side) of the display layer forming section 12 with respect to the transfer direction. The first voltage application section 13 has a function to apply an electric field to the display layer 71 formed on the sheet member 2 by the display layer forming section 12. As shown in FIG. 7, the first voltage application section 13 includes an application electrode 131, and a power supply source (a voltage application unit) 132 that supplies electrical power to the application electrode 131.

The application electrode 131 is provided opposite to the belt conveyor 11 with a gap provided therebetween, and in a manner not to contact the display layer 71 when the sheet member 2 transferred by the belt conveyor 11 is placed opposite the application electrode 131. Also, the application electrode 131 is equipped with a plurality of needle-like needle sections 131a protruding toward the belt conveyor 11 and arranged in the y-axis direction. The second voltage application section 14 is provided above the belt conveyor 11, and in front of the first voltage application section 13 with respect to the transfer direction. The second voltage application section 14 has a function to exert an electrical field to the display layer 71, like the first voltage application section 13.

As shown in FIG. 8, the second voltage application section 14 has an application electrode 141, and a power supply source (a voltage application unit) 142 that supplies electrical power to the application electrode 141. The application electrode 142 has generally the same structure as that of the application electrode 131 described above. More specifically, the application electrode 141 is provided opposite the belt conveyor 11 with a gap provided therebetween, and in a manner not to contact the display layer 71 when the sheet member 2 transferred by the belt conveyor 11 is placed opposite the application electrode 141. Also, the application electrode 141 is equipped with a plurality of needle-like needle sections 141a protruding toward the belt conveyor 11 and arranged in the y-axis direction.

The imaging/evaluation section 15 is provided above the belt conveyor 11 and in front of the second voltage application section 14 with respect to the transfer direction. The imaging/evaluation section 15 has a function to image the state of the display layer 71 after having been subject to the effect of electrical field by the second voltage application section 14, and a function to evaluate the display characteristic of the display layer 71 based on the result. The imaging/evaluation section 15 has an imaging section 151 and a display characteristic evaluation section 152.

The imaging section 151 is provided in a manner to be able to image the state of the entire region of the display layer 71, in other words, the state of the entire microcapsules 711, from above the display layer 71. In accordance with the present embodiment, a linear image sensor is used as the imaging section 151. In other words, as shown in FIG. 9, the imaging section 151 has a scanner 151a with a plurality of photodiodes (imaging elements) arranged in one column (i.e., one-dimensionally) in a direction (y-axis direction) orthogonal to the transfer direction. The scanner 51 scans across the display layer 71 on the sheet member 2 that is transferred by the belt conveyor 11, thereby obtaining an image of the entire area of the display layer 71. According to the imaging section 151 with such a structure, transfer movements of the sheet member 2 by the belt conveyor 11 can be used as scanning movements, whereby an image of the entire area of the display layer 71 can be readily and effectively obtained.

It is noted that the imaging section 151 is not limited to a linear image sensor, and for example, an area image sensor may be used as the imaging section 151. In this case, an imaging device with a plurality of photodiodes arranged laterally and longitudinally (i.e., two-dimensionally) may be prepared, and the entire area of the display layer 71 is imaged at once by the imaging device in the state in which the sheet member 2 transferred by the belt conveyor 11 is stopped at a predetermined location, whereby an image of the entire area of the display layer 71 can be obtained.

The display characteristic evaluation section 152 is equipped with, for example, a computer, and evaluates the display characteristic of the display layer 71 based on the image (image data) of the display layer 71 imaged by the imaging section 151. This operation is described below in greater detail.

The discriminating section 16 is provided in front of the imaging/evaluation section 15 with respect to the transfer direction. The discriminating section 16 has a function to eliminate the display layer 71 if the display characteristic evaluated by the imaging/evaluation section 15 does not reach a predetermined level.

As shown in FIG. 10A, the discrimination section 16 has an arm 161. The arm 161 can be moved back and forth in a direction orthogonal to the transfer direction, and can assume a state in which the arm 161 is deployed over the belt conveyor 11, and a state in which the arm 161 is evacuated from the belt conveyor 11. The discrimination section 16 advances the arm 161 over the belt conveyor 11, as shown in FIG. 10B, when the sheet member 2 on which the display layer 71 passes in front of the arm 161 when the imaging/evaluation section 15 has evaluated (judged) that the display characteristic thereof does not reach the predetermined level, thereby pushing and removing the sheet member 2 from the belt conveyor 11.

The circuit substrate bonding section 17 is provided above the belt conveyor 11, and in front of the discrimination section 16 with respect to the transfer direction. The circuit substrate bonding section 17 has a function to bond a prefabricated circuit substrate 6 to the display layer 71.

Manufacturing Method and Evaluation Method

A manufacturing method for manufacturing the display device 5 and a display characteristic evaluation method for evaluating the display device 5 using the manufacturing apparatus 1 described above will be described. The method for manufacturing the display device 5 includes a sheet member preparation step, a display layer forming step, a first voltage application step, a second voltage application step, an imaging/evaluation step, a discrimination step, and a circuit substrate bonding step. On the other hand, the characteristic evaluation method includes, among the aforementioned steps, the first voltage application step, the second voltage application step and the imaging/evaluation step.

Sheet Member Preparation Step

First, a sheet member 2 to be transferred by the belt conveyor 11 is prepared. As shown in FIG. 11, the sheet member 2 has a structure in which an insulation layer 21 having insulation property and a conductive layer 22 having electrical conductivity are laminated in their thickness direction. The sheet member 2 may be obtained by, for example, preparing a sheet-like insulation layer 21, and forming a conductive layer 22 on one surface of the insulation layer 21 by any one of various film forming methods. The insulation layer 21 of such a sheet member 2 composes the protective sheet 73 of the display device 5. On the other hand, the conductive layer 22 composes the common electrode 72. For this reason, as constituent materials of the insulation layer 21 and the conductive layer 22, the constituent materials of the protective sheet 73 and the common electrode 72 described above can be used.

Display Layer Forming Step

Then, a display layer 71 is formed on the sheet member 2. More specifically, first, the sheet member 2 is placed on the belt conveyor 11 with the conductive layer 22 facing upward. Then, when the sheet member 2 being carried by the belt conveyor 11 passes below the nozzle 121 of the display layer forming section 12, the mixed liquid 3 is ejected through the nozzle aperture 122. By this, the mixed liquid 3 is continuously coated on the upper surface of the sheet member 2 along the entire area in the width direction (the direction orthogonal to the transfer direction), whereby the display layer 71 is obtained. It is noted that, after the mixed liquid 3 has been coated on the sheet member 2, the top surface may be smoothed out by a squeegee or the like, if necessary.

FIG. 13 is a cross-sectional view of the display layer 71 formed in this step. As shown in FIG. 13, microcapsules 711 having different particle sizes are mixed and present in the display layer 71. Further, some of the microcapsules 711 have generally the same particle size, but they may be locally gathered toward the lower side (on the side of the conductive layer 22) or locally gathered toward the upper side in a mixed state in the display layer 71. It is noted that those of the microcapsules 711 that are separated from the conductive layer 22 may be referred to, for the sake of description, as “floated” microcapsules.

Due to the differences in particle size present among the plural microcapsules 711 and the differences in degree of floating from the conductive layer 22, voltages to be applied to the microcapsules 711 may have different magnitudes even when an equal electric field is applied across the entire area of the display layer 71, whereby the responsiveness and the distance of electrophoretic migration (electrophoretic speed) of the positively charged and negatively charged particles A and B may differ among the microcapsules 711.

For this reason, for example, when the display layer 71 is viewed from the upside in FIG. 13, the following problem may occur. Even when equal electric fields are applied to the entire area of the display layer 71 for equal lengths of time to have the entire area of the display layer 71 exhibit a white display state, portions displayed in black color and portions displayed in gray color may appear, as shown in FIG. 14A. In contrast, even when equal electric fields are applied to the entire area of the display layer 71 for equal lengths of time to have the entire area of the display layer 71 exhibit a black display state, portions displayed in white color and portions displayed in gray color may appear, as shown in FIG. 14B.

In this manner, because of the presence of improper portions T2 in which a proper color is not displayed (or an improper color is displayed) against proper portions T1 in which the proper color is displayed, the display characteristic of the fabricated display device 5 is deteriorated, which makes it difficult to display a desired image. It is noted that the degree of deterioration of the display characteristic is in proportion to the size of regions (the total area) of the improper portions T2, wherein, the greater the occupying area of the improper portions T2 with respect to the display surface 51, the more the display characteristic of the fabricated display device 5 is deteriorated. In the following steps, such display characteristics of the display device 5 are evaluated, and those of the display layers 71 that do not satisfy a predetermined level are removed.

First Voltage Application Step

Then, the entire area (an examination area) of the display layer 71, when observed from above (from the side of the application electrode 131), is placed in a white (first display color) display state (hereinafter, simply referred to as a “white display state” in the present step). More specifically, while the sheet member 2 carried by the belt conveyor 11 is passing below the application electrode 131 of the first voltage application section 13, an alternate voltage (a preliminary voltage) V1 (hereafter simply referred to as a “voltage V1”) shown in FIG. 15 is applied by the power supply 132. At this moment, the conductive layer 22 of the sheet member 2 is grounded, such that a potential difference is generated between the application electrode 131 and the conductive layer 22, generating an electric field between them. While the sheet member 2 is passing below the application electrode 131, the application electrode 131 is separated at a predetermined constant distance from the conductive layer 22, and the sheet member 2 is transferred at a constant speed by the belt conveyor 11, whereby equal electric fields are applied to the entire area of the display layer 71 located between the application electrode 131 and the conductive layer 22 for equal lengths of time.

In this manner, as the display layer 71 that is being carried in the x-axis direction is passed below the application electrode 131 that extends in the y-axis direction, the application electrode 131 can be made smaller in size (the width in the x-axis direction can be made shorter). For this reason, generation of irregularities in the voltage distribution along portions of the application electrode 131 can be prevented or suppressed, whereby equal electric fields can be applied more securely to the entire area of the display layer 71.

In particular, in accordance with the present embodiment, the application electrode 131 has the plurality of needle-like needle sections 131a, lines of electric force are gathered at the tip of each of the needle-like sections 131a, whereby electric fields can be effectively generated between the application electrode 131 and the conductive layer 22. Furthermore, in accordance with the present embodiment, the application electrode 131 is installed in a manner not to contact the display layer 71, such that, when the sheet member 2 passes below the application electrode 131, damage to the display layer 71 (i.e., the microcapsules 711) that may be caused by contact with the application electrode 131 can be securely prevented.

The separation distance between the conductive layer 22 and the application electrode 131 may preferably be between 1.1 times and 100 times the thickness of the display layer 71, without any particular limitation. By satisfying such a range, contacts between the application electrode 131 and the display layer 71 can be reliably prevented; and when the voltage V1 shown in FIG. 14 is applied to the application electrode 131, a transient response voltage V1c to be described below can be more reliably generated.

The voltage V1 will be described. As shown in FIG. 15A, the voltage V1 is an alternate voltage having a saw teeth like waveform. More specifically, the voltage V1 is an alternate voltage that alternately and periodically repeats a voltage elevation and a rapid voltage drop (in which the voltage drops in a shorter time than the time required for the voltage elevation).

It is noted that an air layer or the binder 712 (hereinafter referred to as an “intervening section K”) is present between the microcapsules 711 and the application electrode 131. Such a structure may be expressed by an equivalent circuit shown in FIG. 16. Cc and Rc in FIG. 16 are a capacitance component and a resistance component of the microcapsule 711, and Cb in FIG. 16 is a capacitance component of the intervening section K.

In this manner, the intervening section K is present between the microcapsule 711 and the application electrode 131, such that, even when the voltage V1 is applied to the application electrode 131, the voltage V1 would not be applied as is to the microcapsule 711, but a voltage V1c shown in FIG. 15B is applied to the microcapsule 711. The voltage V1c alternately and periodically repeats a voltage (a transient response voltage) V1c′ that is generated when the voltage V1 rapidly drops (between time T₁ and time T₂, between time T₃ and time T₄, etc.) and a voltage V1c″ that is generated when the voltage V1 gently rises (between time T₀ and time T₁, between time T₂ and time T₃, etc.).

When the voltage V1 rapidly drops, the transient voltage V1c′ generated as a result of the rapid voltage drop is applied to the microcapsule 711. The voltage V1c′ can be expressed as ΔV1₀/{1+∈ᵣ(d_{b}/d_{c})}, where ΔV1₀ is a maximum difference between high and low values of the voltage V1, ∈ᵣ is a dielectric constant of the microcapsule 711 (the entire microcapsule 711 including the electrophoretic dispersion liquid, the capsule body 711a, etc.), d_{b} is the thickness of the intervening section K (i.e., the separation distance between the microcapsule 711 and the application electrode 131), and d_{c} is the particle size or diameter (the length in the z-axis direction) of the microcapsule 711.

On the other hand, when the voltage V1 gently elevates, as the resistance of the intervening section K is large, a major portion of the voltage V1 is applied to the intervening portion K, and almost no voltage is applied to the microcapsule 711. Therefore, the voltage V1c″ is substantially zero (0). In this instance, as the elevation of the voltage V1 is gentle, a transient voltage, like the voltage V1c′, would not be generated.

Upon application of the voltage V1c to the microcapsule 711, when the voltage V1c′ is being generated, an electric field acts on the microcapsule 711 with the application electrode 131 on a negative potential and the conductive layer 22 on a positive potential, such that the white positively charged particles A move by electrophoresis toward the application electrode 131, and the black negatively charged particles B move by electrophoresis toward the conductive layer 22. By using such electrophoretic movements of the positively charged and negatively charged particles A and B, the entire area of the display layer 71 is placed in a white display state.

As described above (and also shown in FIG. 17), a plurality of microcapsules 711 with different particle sizes and a plurality of microcapsules 711 with different floating levels are mixed and present in the display layer 71. In other words, a plurality of microcapsules 711 with different separation distances d_{b} from the application electrode 131 are mixed and present in the display layer 71. As is clear from the aforementioned formula, ΔV1₀/{1+∈ᵣ(d_{b}/d_{c})}, the greater the separation distance d_{b} from the application electrode 131, the smaller the V1c′ becomes, whereby the responsiveness and the distance of electrophoretic migration (electrophoretic speed) of the positively charged and negatively charged particles A and B contained in the microcapsules 711 would lower.

Accordingly, in the present step, it is preferred to apply the voltage V1 to the application electrode 131 for a period of time sufficiently longer than the time required for any of the plurality of microcapsules 711 contained in the display layer 71 whose separation distance d_{b} from the application electrode 131 is the greatest (in other words, with the smallest value of V1c′) to assume a white display state. By this, the entire area of the display layer 71 can be more reliably set to a white display state.

With respect to the voltage V1, ΔV1₀ may preferably be 1V or greater, without any particular limitation. By this, the voltage V1c′ that is sufficient to electrophoretically move the positively charged and negatively charged particles A and B can be applied to each of the microcapsules 711. Also, the upper limit value of ΔV1₀ may be less than 100 kV in view of the safety of the apparatus.

It is noted that, even when the voltage V1 is applied to the application electrode 131, but when the voltage V1c′ is not generated, almost no current flows between the application electrode 131 and the conductive layer 22, such that almost no power is consumed. For this reason, even when the voltage V1 is set at a relatively large value, power-saving drive can be performed. In other words, with the voltage V1, the electrophoretic migration speed of the positively charged and negatively charged particles A and B can be increased, while power saving can be achieved.

Also, with respect to the voltage V1, the greater the amount of voltage change (the amount of voltage drop) per unit time at the time of voltage drop, the better, and it may preferably be 1V/ms or greater, and more preferably be ∞/ms. As a result, the voltage V1 can be rapidly changed (dropped), and accordingly, the voltage V1c′ can be more reliably generated.

Further, with respect to the voltage V1, the amount of voltage change per unit time at the time of voltage elevation may preferably be about 0.1V/s to about 1.0 V/ms, and more preferably about 0.1-0.5V/ms. As a result, rapid elevation of the voltage V1 can be prevented, and generation of a transient voltage (such as V1c′) at the time of voltage elevation can be prevented. For this reason, it is possible to prevent generation of an electric field in an opposite direction with respect to the electric field that wants to be applied to the microcapsules 711 for setting the display layer 71 in a white display state (in other words, an electric field with the application electrode 131 on a positive potential and the conductive layer 22 on an negative potential), whereby the positively charged and negatively charged particles A and B can be smoothly moved by electrophoresis to their desired directions, respectively. Furthermore, by setting the aforementioned range, the time required for elevating the voltage V1 to a predetermined value can be made relatively short, such that the frequency of generating the voltage V1c′ per unit time can be increased. Therefore the entire area of the display layer 71 can be set to a white display state in a shorter period of time.

Moreover, with respect to the voltage V1, the period of time in which the voltage elevates (the period of time from time T₀ to time T₁, the period of time from time T₂ to time T₃, etc.) may preferably be sufficiently greater than the circuit time constant, and the period of time in which the voltage rapidly drops (the period of time from time T₁ to time T₂, the period of time from time T₃ to time T₄, etc.) may preferably be sufficiently lower than the circuit time constant. In particular, the period of time in which the voltage elevates may preferably be three times the circuit time constant or greater. It is noted that the circuit time constant is defined as Rc {CcCb/(Cc+Cb)}.

Also, with the voltage V1, its frequency may preferably be about 0.1 Hz-about 100 MHz, without any particular limitation, and more preferably, 100 Hz-10 kHz. Therefore, the time for elevating the voltage in each period of the voltage V1 can be sufficiently secured, such that the maximum high-low level difference ΔV1₀ of the voltage V1 can be made greater. As a result, the voltage V1c′ can be more securely generated. In addition, the frequency of generating the voltage V1c′ per unit time can be increased, whereby the electrophoretic migration distance of the positively charged and negatively charged particles A and B per unit time can be made greater. As a result, the entire area of the display layer 71 can be set to a white display state in a shorter period of time.

Second Voltage Application Step

Next, the entire area (the examination region) of the display layer 71 is changed to a gray (the third display color) display state as a whole, as the display layer 71 is observed from above (from the side of the application electrode 141) (hereinafter also simply referred to as a “gray display state” in the present step).

More specifically, while the sheet member 2 equipped with the display layer 71 that is set in a white display state by the first voltage application step passes below the application electrode 141 of the second voltage application section 14 as being carried by the belt conveyor 11, an alternate voltage V2 (hereafter simply referred to as a “voltage V2”) shown in FIG. 18 is applied by the power supply 142. At this moment, the conductive layer 22 of the sheet member 2 is grounded, such that a potential difference is generated between the application electrode (the second electrode) 141 and the electrode layer (the first electrode) 22, generating an electric field between them. While the sheet member 2 is passing below the application electrode 141, the application electrode (the second electrode) 141 is separated at a predetermined constant distance from the electrode layer (the first electrode) 22, and the sheet member 2 is transferred at a constant speed by the belt conveyor 11, whereby equal electric fields are applied to the entire area (the examination region) of the display layer 71 located between the application electrode 141 and the conductive layer 22 for equal lengths of time.

In this manner, as the display layer 71 that is being carried in the x-axis direction is passed below the application electrode 141 that extends in the y-axis direction, the application electrode 141 can be made smaller in size (the width in the x-axis direction can be made shorter). For this reason, generation of irregularities in the voltage distribution along portions of the application electrode 141 can be prevented or suppressed, whereby equal electric fields can be applied more securely to the entire area of the display layer 71.

In particular, in accordance with the present embodiment, the application electrode 141 has the plurality of needle-like needle sections 141a, lines of electric force are gathered at the tip of each of the needle-like sections 141a, whereby electric fields can be effectively generated between the application electrode (the second electrode) 141 and the conductive section (the first electrode) 22. Furthermore, in accordance with the present embodiment, the application electrode 141 is installed in a manner not to contact the display layer 71, such that, when the sheet member 2 passes below the application electrode 141, damage to the display layer 71 (i.e., the microcapsules 711) that may be caused by contact with the application electrode 141 can be securely prevented.

The separation distance between the conductive layer 22 and the application electrode 141 may preferably be between 1.1 times and 100 times the thickness of the display layer 71, without any particular limitation. By satisfying such a range, contacts between the application electrode 141 and the display layer 71 can be reliably prevented; and when the voltage V2 is applied to the application electrode 141, a transient response voltage V2c′ to be described below can be more reliably applied to the microcapsules 711.

Next, the voltage V2 will be described. As shown in FIG. 18A, the voltage V2 is an alternate voltage having a saw teeth like waveform. More specifically, the voltage V2 is an alternate voltage that alternately and periodically repeats a voltage drop and a rapid voltage elevation (in which the voltage elevates in a shorter time than the time required for the voltage drop). The voltage V2 has a waveform symmetrical to that of the voltage V1 through a 0 voltage line.

It is noted that an intervening section K is present between the microcapsules 711 and the application electrode 141, and therefore, even when the voltage V2 is applied to the application electrode 141, the voltage V2 would not be applied as is to the microcapsule 711, but a voltage V2c shown in FIG. 18B is applied to the microcapsules 711. The voltage V2c alternately and periodically repeats a voltage (a transient response voltage) V2c′ that is generated when the voltage V2 rapidly elevates (between time T₁ and time T₂, between time T₃ and time T₄, etc.) and a voltage V2c″ that is generated when the voltage V2 gently drops (between time T₀ and time T₁, between time T₂ and time T₃, etc.).

When the voltage V2 rapidly elevates, the transient voltage V2c′ generated as a result of the rapid voltage elevation is applied to the microcapsule 711. Like the voltage V1c′ described above, the voltage V2c′ can be expressed as ΔV2₀/{1+∈ᵣ(d_{b}/d_{c})}, where ΔV2₀ is a maximum difference between high and low values of the voltage V1, and d_{b} is a separation distance between the application electrode 141 and the microcapsule 711.

On the other hand, when the voltage V2 gently drops, as the resistance of the intervening section K is large, a major portion of the voltage V2 is applied to the intervening portion K, and almost no voltage is applied to the microcapsules 711. Therefore, the voltage V2c″ is substantially zero (0). In this instance, as the drop of the voltage V2 is gentle, a transient voltage, like the voltage V2c′, would not be generated.

Upon application of the voltage V2c to the microcapsules 711, when the voltage V2c′ is being generated, an electric field acts on the microcapsules 711 with the application electrode 141 on a positive potential and the conductive layer 22 on a negative potential, such that the white positively charged particles A smoothly move by electrophoresis from the side of the application electrode 141 toward the conductive layer 22, and the black negatively charged particles B smoothly move by electrophoresis from the side of the conductive layer 22 toward the application electrode 141.

In the present step, as the display layer 71 is made to change into a gray display, the application of the voltage V2 to the application electrode 141 is stopped before the positively charged particles A reach the conductive layer 22 and the negatively charged particles B reach the application electrode 141. More specifically, when the positively charged and negatively charged particles A and B are both gathered in a mixed state in the central area of the microcapsule 711, the application of the voltage V2 to the application electrode 141 is stopped, whereby the display layer 71 is turned into a gray display state as a whole.

Here, the aforementioned state of “gray display as a whole” means a state in which those of the microcapsules 711 in a gray display state occupy a major portion of the display surface, while those of the microcapsules 711 in a white display state (improper portions T2) and those of the microcapsules 711 in a black display state (improper portions T2) are also present in the display surface, as shown in FIG. 19. This is because, as described above, a plurality of microcapsules 711 having different particle sizes and a plurality of microcapsules 711 with different degrees of floating are present in a mixed state in the display layer 71, and therefore the responsiveness and electrophoretic migration speed of the positively charged and negatively charged particles A and B are different among the plurality of microcapsules 711, such that the entire microcapsules 711 cannot be placed in a gray display state.

It is noted that the application time of the voltage V2 to turn the display layer 71 in a gray display state as a whole can be set as follows. For example, an average value of the separation distances d_{b} between the microcapsules 711 and the application electrode 141 is obtained by calculation, experiment (measurement) and the like, an application time of the voltage V2 which causes those of the microcapsules 711 having the obtained average value to exhibit a gray display state is calculated based on various parameters, such as, the average value, the particle size of the microcapsules, the electrophoretic migration speed of the positively charged and negatively charged particles A and B, and the like, and the calculated time can be set as the application time of the voltage V2. By this, the display layer 71 can be more reliably turned to a gray display state as a whole.

Also, as another method, for example, the voltage V2 may be applied to the application electrode 141 while observing the display layer 71 from above, and the application of the voltage V2 to the application electrode 141 may be stopped when the display layer 71 turns to a gray display state as a whole (when the number of those of the microcapsules 711 in a gray color state becomes the maximum), whereby the display layer 71 can be more reliably turned to a gray display state as a whole.

In connection with the voltage V2, ΔV2₀ may preferably be 1V or greater, without any particular limitation. By this, the voltage V2c that is sufficient to electrophoretically move the positively charged and negatively charged particles A and B can be applied to each of the microcapsules 711. Also, the upper limit value of ΔV2₀ may be less than 100 kV in view of the safety of the apparatus.

It is noted that, even when the voltage V2 is applied to the application electrode 141, almost no current flows between the application electrode 141 and the conductive layer 22 when the voltage V2c′ is not generated, such that almost no power is consumed. For this reason, even when the voltage V2 is set at a relatively large value, power-saving drive can be performed. In other words, with the voltage V2, the electrophoretic migration speed of the positively charged and negatively charged particles A and B can be increased, while power saving can be achieved.

Also, with respect to the voltage V2, the greater the amount of voltage change (the amount of voltage elevation) per unit time at the time of voltage elevation, the better, and it may preferably be 1V/ms or greater, and more preferably be ∞/ms. As a result, the voltage V2 can be rapidly changed, and accordingly, the voltage V2c′ can be more reliably generated.

Also, in connection with the voltage V2, the amount of voltage change per unit time at the time of voltage drop may preferably be about 0.1V/s to about 1.0 V/ms, and more preferably about 0.1-0.5V/ms. As a result, rapid drop of the voltage V2 can be prevented, and generation of a transient responsive voltage at the time of voltage drop can be prevented. For this reason, it is possible to prevent generation of an electric field in an opposite direction with respect to the electric field that wants to be applied to the microcapsules 711 for setting the display layer 71 in a gray display state (in other words, an electric field with the application electrode 141 on a negative potential and the conductive layer 22 on a positive potential), whereby the positively charged and negatively charged particles A and B can be smoothly moved by electrophoresis to their desired directions, respectively. Furthermore, by setting the aforementioned range, the time required for dropping the voltage V2 to a predetermined value can be made relatively short, such that the frequency of generating the transient response voltage V2c′ per unit time can be increased. Therefore the entire area of the display layer 71 can be set to a gray display state in a shorter period of time.

Moreover, with respect to the voltage V2, the period of time in which the voltage drops (the period of time from time T₀ to time T₁, the period of time from time T₂ to time T₃, etc.) may preferably be sufficiently greater than the circuit time constant, and the period of time in which the voltage rapidly elevates (the period of time from time T₁ to time T₂, the period of time from time T₃ to time T₄, etc.) may preferably be sufficiently smaller than the circuit time constant. In particular, the period of time in which the voltage drops may preferably be three times the circuit time constant or greater. It is noted that, as described above, the circuit time constant is defined as Rc {CcCb/(Cc+Cb)}.

Also, with respect to the voltage V2, its frequency may preferably be about 0.1 Hz-about 100 MHz, without any particular limitation, and more preferably, 100 Hz-10 kHz. Therefore, the time for dropping the voltage in each period of the voltage V2 can be sufficiently secured, such that a greater high-low level difference (ΔV2₀) of the voltage V2 can be created. As a result, the transient response voltage V2c′ can be more securely generated. In addition, the frequency of generating the transient response voltage V2c′ per unit time can be increased, whereby the electrophoretic migration distance of the positively charged and negatively charged particles A and B per unit time can be made greater. As a result, the entire area of the display layer 71 can be turned to a gray display state in a shorter period of time.

Imaging/Evaluation Step

Next, the display layer 71 is imaged from above, and display characteristics of the display layer 71 are evaluated. More specifically, first, the display layer 71 on the sheet member 2 that is transferred by the belt conveyor 11 is scanned (imaged) by the scanner 151a, whereby image data of the entire area (examination area) of the display layer 71 as viewed from above is obtained. In this manner, as the display layer 71 is imaged by the imaging elements provided on the scanner 151a, such that clear image data of the display layer 71 can be obtained. Also, by imaging the display layer 71 from above, in other words, from the side where the sheet member 2 is not formed, light absorption by members other than the display layer 71 can be prevented, whereby much clearer image data of the display layer 71 can be obtained.

The display characteristic evaluation section 152 evaluates the display characteristic of the display layer 71 based on the image data of the display layer 71 obtained by the scanner 151a. More specifically, as the display layer 71 is set in a gray display state as a whole in the second voltage application step, portions in a gray display state among the display layer 71 are determined as proper portions T1, and other portions (in other words, portions in a white display state and portions in a black display state) are determined as improper portions T2. Evaluation is made based on the occupying area of the improper portions T2 with respect to the entire area of the display layer 71.

Specifically, the display characteristic evaluation section 152 evaluates that, the smaller the occupying area of the improper portions T2, the fewer variations in responsiveness and electrophoretic migration speed of positively charged and negatively charged particles A and B in each of the microcapsules, and thus the display layer 71 has excellent display characteristic. In reverse, the display characteristic evaluation section 152 evaluates that, the greater the occupying area of the improper portions T2, the greater the variations in responsiveness and electrophoretic migration speed of positively charged and negatively charged particles A and B in each of the microcapsules, and thus the display layer 71 has deteriorating display characteristic. According to such an evaluation method, the display characteristic of the display layer 71 can readily evaluated. Also, the evaluation reference can be clearly defined, such that equal evaluation can be made among individual display layers 71.

Also, the display characteristic evaluation section 152 is provided with a threshold value for the occupying area of improper portions T2, for judging as to whether the display characteristic of the display layer 71 reaches a predetermined level. The display characteristic evaluation section 152 evaluates that the display layer 71 is above the predetermined level when the occupying area of improper portions T2 is lower than the threshold value, and the display layer 71 is below the predetermined level when the occupying area of improper portions T2 is higher than the threshold value. By setting the threshold value in this manner, evaluation of display characteristics by the display characteristic evaluation section 152 can be simplified. It is noted that the threshold value to be set is not limited to one value, but multiple values may be set. When multiple threshold values are set, for example, the display characteristic of the display layer 71 can be evaluated in one of multiple stages, such as, for example, “excellent,” “good,” “acceptable,” “unacceptable” or the like.

Here, in the microcapsules 711 included in the portions in a white display state among the improper portions T2, the positively charged and negatively charged particles A and B therein have almost no electrophoretic movements even when the transient response voltage V2c′ is applied in the second voltage application step. In other words, the separation distance d_{b} of the microcapsules 711 included in the portions in a white display state to the application electrode 141 is greater than the separation distance d_{b} of the microcapsules 711 included in the proper portions T1 to the application electrode 141. Therefore, the display characteristic evaluation section 152 judges (specifies) that the microcapsules 711 included in the portions in a white display state have particle sizes smaller than the particle size of the microcapsules 711 included in the proper portions T1. By making such a judgment, the display characteristic of the display layer 71 can be evaluated in more detail.

On the other hand, in the microcapsules 711 included in the portions in a black display state among the improper portions T2, the positively charged and negatively charged particles A and B therein have excessive electrophoretic movements by the application of the transient response voltage V2c′ in the second voltage application step. In other words, the separation distance d_{b} of the microcapsules 711 included in the portions in a black display state to the application electrode 141 is shorter than the separation distance d_{b} of the microcapsules 711 included in the proper portions T1 to the application electrode 141. Therefore, the display characteristic evaluation section 152 judges (specifies) that the microcapsules 711 included in the portions in a black display state have particle sizes larger than the particle size of the microcapsules 711 included in the proper portions T1, or have greater degrees of floating than that of the microcapsules 711 included in the proper portions T1. By making such a judgment, the display characteristic of the display layer 71 can be evaluated in more detail.

Discrimination Step

Then, those of the sheet members 2 having the display layers 71 formed thereon whose display characteristics have been evaluated as not reaching the predetermined level in the imaging/evaluation step are removed from the belt conveyor 11. More specifically, when a sheet member 2 formed with a display layer 71 whose display characteristic does not reach the predetermined level passes the discrimination section 16 as it is transferred by the belt conveyor 11, the arm 161 is advanced over the belt conveyor 11, thereby pushing the sheet member 2, whereby the sheet member 2 is removed from the belt conveyor 11. On the other hand, when a sheet member 2 formed with a display layer 71 whose display characteristic reaches the predetermined level passes the discrimination section 16 as it is transferred by the belt conveyor 11, the arm 161 is placed in a stated evacuated from the belt conveyor 11, whereby the sheet member 2 is allowed to be transferred on the belt conveyor 11.

By the discrimination step described above, only those of the sheet members 2 formed with display layers 71 whose display characteristic has been evaluated as satisfying the predetermined level in the imaging/evaluation step can be advanced to the following step (the circuit substrate bonding step). For this reason, only display devices 5 having the display characteristic that satisfies the predetermined level can be manufactured by the apparatus 1, and thus the manufacturing yield of display devices 5 is improved. Furthermore, by removing those of the display layers 71 whose display characteristic does not satisfy the predetermined level in this relatively early stage, the use of components that may be wasted can be prevented, and thus the manufacturing cost of the display device 5 can be reduced.

Circuit Substrate Bonding Step

Then, a circuit substrate 6 is bonded to the sheet member 2 that has been selected by the discrimination step, in other words, the sheet member 2 formed with the display layer 71 whose display characteristic satisfies the predetermined level. More specifically, the circuit substrate 6 that has been independently manufactured (has been prepared in advance) is bonded to the upper surface of the display layer 71 that has been transferred to the circuit substrate bonding section 17 by the belt conveyor 11. Such bonding may be accomplished by, for example, using the adhesive force of the binder 712 contained in the display layer 71, or they may be bonded together with adhesive or the like. The circuit substrate 6 may be bonded to the sheet member 2 while being transferred by the belt conveyor 11, or the circuit substrate 6 may be bonded while the transfer is stopped.

The display device 5 is obtained by the steps described above. According to the manufacturing method described above, the display device 5 having the display characteristic above the predetermined level can be efficiently manufactured.

Also, according to the evaluation method (i.e., the evaluation method in accordance with the embodiment of the invention) for evaluating the display characteristic of the display layer 71 which is included in the manufacturing method, the display characteristic of the display layer 71 can be readily and reliably evaluated. In particular, because the first voltage application step is provided, the states (uneven distribution positions) of the positively charged and negatively charged particles A and B in each of the microcapsules 711 can be made uniform before conducting the second voltage application step, such that the display characteristic of the display layer 71 can be more accurately evaluated.

Furthermore, according to the manufacturing apparatus 1, the evaluation step of evaluating the display layer 71 can be incorporated in the process for manufacturing the display device 5, in other words, the display characteristic of the display layer 71 can be evaluated in the course of manufacturing the display device 5, the display device 5 having display characteristic above the predetermined level can be efficiently manufactured.

### Second Embodiment

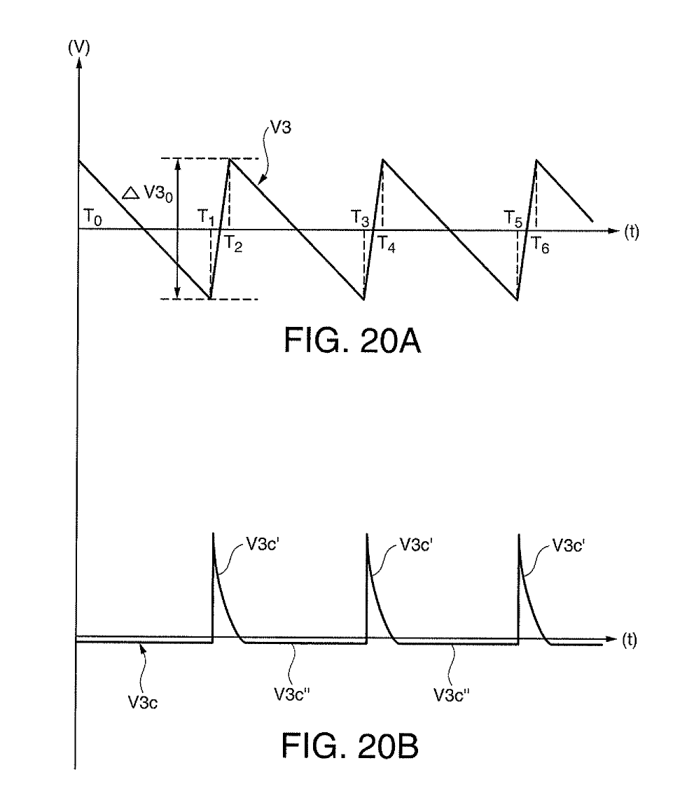

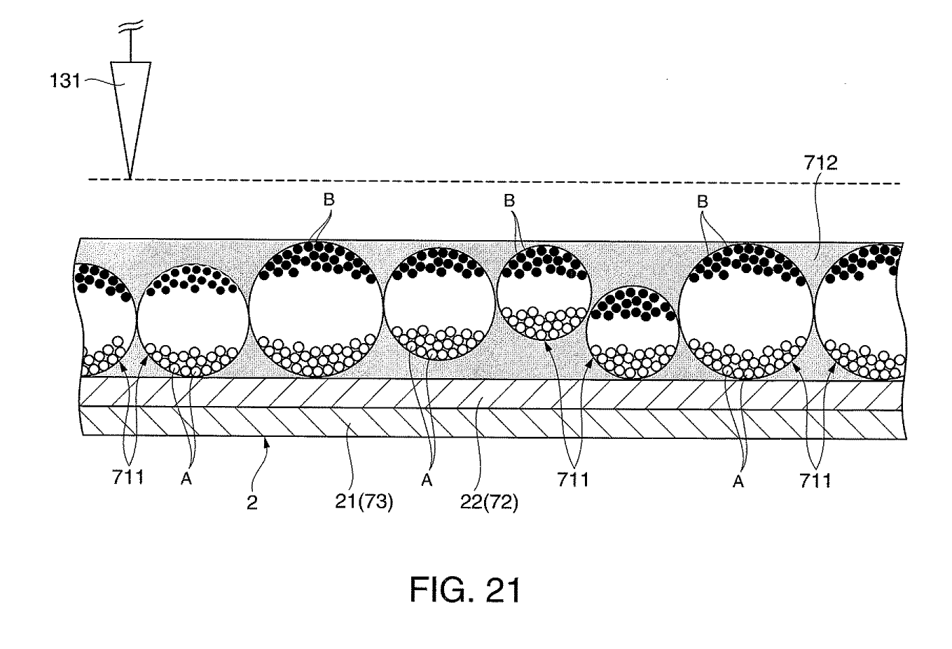

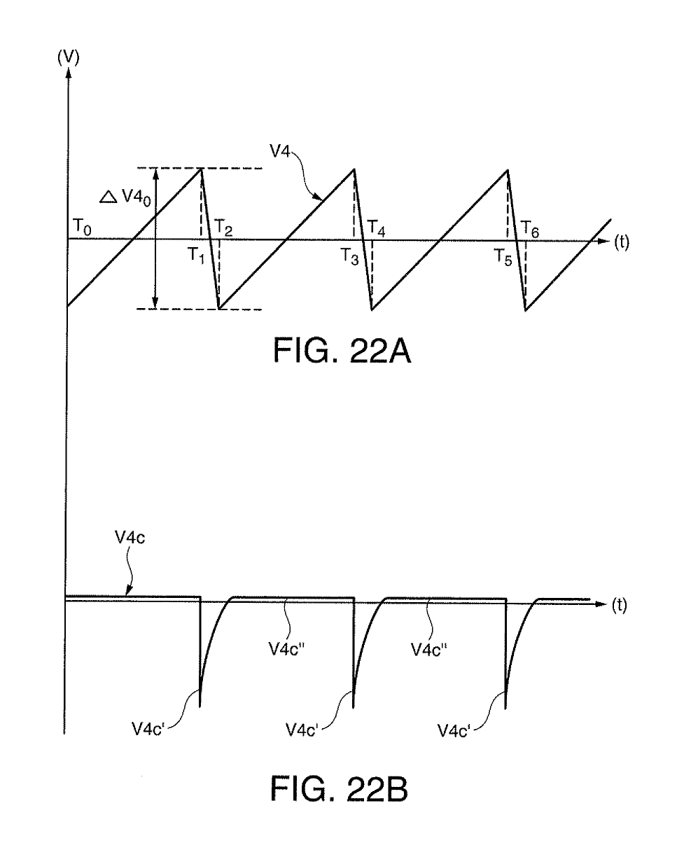

Next, a method for manufacturing (a method for evaluating) a display sheet in accordance with a second embodiment of the invention will be described. FIGS. 20A and 20B show patterns of voltages to be applied to the application electrode of the first voltage application section. FIG. 21 is a cross-sectional view showing a state of the display layer after treatment by the first voltage application section. FIGS. 22A and 22B show patterns of voltages to be applied to the application electrode of the second voltage application section.

The manufacturing apparatus in accordance with the second embodiment is described below, mainly focusing on differences from the first embodiment, and description of similar features are omitted.

The manufacturing apparatus 1 in accordance with the present embodiment (the evaluation method in accordance with the present embodiment) has generally the same composition as that of the first embodiment described above, except that the voltage to be applied to the application electrode 131 of the first voltage application section 13 and the voltage to be applied to the application electrode 141 of the second voltage application section 14 are different.

In accordance with the present embodiment, in the first voltage application section 13, a voltage (a preliminary voltage) is applied to the application electrode 131 such that the entire area of the display layer 71, when observed from above (from the side of the application electrode 131), is placed in a black (second display color) display state. In other words, a voltage that causes the positively charged particles A to electrophoretically move toward the conductive layer 22 and the negatively charged particles B to electrophoretically move toward the application electrode 131 is applied to the application electrode 131.

More specifically, a voltage V3 shown in FIG. 20A is applied to the application electrode 131 by the power supply 132. As shown in FIG. 20A, the voltage V3 is an alternate voltage that alternately and periodically repeats a voltage drop and a rapid voltage elevation (in which the voltage elevates in a shorter time than the time required for the voltage drop). The voltage V3 has a waveform similar to that of the voltage V2 applied to the application electrode 141 in the first embodiment described above.

When the voltage V3 is applied to the application electrode 131, a voltage V3c shown in FIG. 20B is applied to the microcapsules 711. The voltage V3c alternately and periodically repeats a transient voltage V3c′ that is generated when the voltage V3 rapidly elevates and a voltage V3c″ that is generated when the voltage V3 gently drops. The voltage V3c also has a waveform similar to that of the voltage V2c described above in the first embodiment above.

Upon application of the voltage V3c to the microcapsules 711, when the voltage V3c′ is being generated, an electric field acts on the microcapsules 711 with the application electrode 131 on a positive potential and the conductive layer 22 on a negative potential, such that the white positively charged particles A move by electrophoresis toward the conductive layer 22, and the black negatively charged particles B move by electrophoresis toward the application electrode 131. Such electrophoretic movements of the positively charged and negatively charged particles A and B are used to set the entire area of the display layer 71 in a black display state, as the display layer 71 is viewed from the upper side.

It is noted that the application time duration of the voltage V3 is substantially the same as the application time duration of the voltage V1 described in the first embodiment, and also various parameters, such as, the maximum difference (ΔV3₀) between high and low values of the voltage V3, the amount of change in the voltage per unit time at the time of voltage drop, the amount of change in the voltage per unit time at the time of voltage elevation, the timing when the voltage elevates (time T₁-T₂, etc.), the timing when the voltage drops (time T₀-T₁, etc.), the frequency and the like are generally the same as those of the voltage V2. Accordingly, detailed description thereof is omitted.

Further, in accordance with the present embodiment, in the second voltage application section 14, a voltage is applied to the application electrode 141 such that the entire area of the display layer 71, when observed from above (from the side of the application electrode 141), is placed in a gray display state as a whole. In other words, a voltage that causes the positively charged particles A to electrophoretically move toward the application electrode 141 and the negatively charged particles B to electrophoretically move toward the conductive layer 22 is applied to the application electrode 141.

More specifically, a voltage V4 shown in FIG. 22A is applied to the application electrode 141 by the power supply 142. As shown in FIG. 22A, the voltage V4 is an alternate voltage that alternately and periodically repeats a voltage elevation and a rapid voltage drop (in which the voltage drops in a shorter time than the time required for the voltage elevation). The voltage V4 has a waveform similar to that of the voltage V1 applied to the application electrode 131 in the first embodiment described above.

When the voltage V4 is applied to the application electrode 141, a voltage V4c shown in FIG. 22B is applied to the microcapsules 711. The voltage V4c alternately and periodically repeats a transient voltage V4c′ that is generated when the voltage V4 rapidly drops and a voltage V4c″ that is generated when the voltage V4 gently elevates. The voltage V4c also has a waveform similar to that of the voltage V1c described above in the first embodiment above.

Upon application of the voltage V4c to the microcapsules 711, when the voltage V4c′ is being generated, an electric field acts on the microcapsules 711 with the application electrode 141 being on a negative potential and the conductive layer 22 being on a positive potential, such that the white positively charged particles A move by electrophoresis toward the application electrode 141, and the black negatively charged particles B move by electrophoresis toward the conductive layer 22. Such electrophoretic movements of the positively charged and negatively charged particles A and B are used to set the entire area of the display layer 71 in a gray display state as a whole, as the display layer 71 is viewed from the upper side (see FIG. 19).

It is noted that the application time duration of the voltage V4 is substantially the same as the application time duration of the voltage V2 described in the first embodiment, and also various parameters, such as, the maximum difference (ΔV4₀) between high and low values of the voltage V4, the amount of change in the voltage per unit time at the time of voltage drop, the amount of change in the voltage per unit time at the time of voltage elevation, the timing when the voltage elevates (time T₀-T₁, etc.), the timing when the voltage drops (time T₁-T₂, etc.), the frequency and the like are generally the same as those of the voltage V1. Accordingly, detailed description thereof is omitted.

In accordance with the present embodiment, although the display layer 71 is turned from the black display state into a gray display state in the second voltage application section 14, in a manner opposite to the first embodiment described above, the display characteristic evaluation section 152 judges that the microcapsules 711 included in portions in a white display state (improper portions T2) have particle sizes larger than the particle size of the microcapsules 711 included in the proper portions T1, or have greater degrees of floating than that of the microcapsules 711 included in portions in the gray display state (the proper portions T1). By making such a judgment, the display characteristic of the display layer 71 can be evaluated in more detail.

On the other hand, the display characteristic evaluation section 152 judges that the microcapsules 711 included in the portions in a black display state (improper portions T2) have particle sizes smaller than the particle size of the microcapsules 711 included in the proper portions T1. By making such a judgment, the display characteristic of the display layer 71 can be evaluated in more detail. The second embodiment can achieve effects similar to those of the first embodiment described above.

Based on each of the illustrated embodiments, the evaluation method, the display sheet manufacturing method and the display sheet manufacturing apparatus are described above. However, the invention is not limited to these embodiments. For example, the evaluation method, the display sheet manufacturing method and the display sheet manufacturing apparatus may be replaced with arbitrary compositions (steps) that exhibit similar functions, or may be provided with additional arbitrary compositions (steps).

What is claimed is:

1. An evaluation method that evaluates display characteristic of a display sheet equipped with a display layer having a plurality of microcapsules containing positively or negatively charged electrophoretic particles, the evaluation method comprising:
applying a voltage across a pair of first electrode and second electrode disposed opposite each other across the display layer, to apply an electric field to an examination region set in at least a portion of an area of the display layer,
wherein the voltage is applied without contacting the second electrode with the display layer.

2. An evaluation method according to claim 1, further comprising:
detecting presence of an improper portion whose display state is improper, which is caused by at least one of a difference in particle size among the microcapsules and a difference in floating level of the microcapsules, through detecting a color difference in the improper portion against a proper portion whose display state is proper.

3. An evaluation method according to claim 2, wherein the display sheet has the display layer and a common electrode provided on one surface side of the display layer in a manner to enclose the plurality of microcapsules, wherein the common electrode also serves as the first electrode, and the presence of an improper portion is detected from the side of the second electrode.

4. An evaluation method according to claim 3, wherein the electrophoretic particles include positively charged particles that are positively charged and negatively charged particles that are in a different color from the positively charged particles and negatively charged, and the display sheet is capable of displaying a first display color with the positively charged particles locally gathered on the side of the second electrode, a second display color with the negatively charged particles locally gathered on the side of the second electrode, and a third display color that is a halftone between the first display color and the second display color.

5. An evaluation method according to claim 4, wherein the voltage that causes the third display color is applied between the first electrode and the second electrode, and portions of the first display color and the second display color are specified as the improper portion.

6. An evaluation method according to claim 5, wherein the voltage is applied between the first electrode and the second electrode such that the positively charged particles move toward the first electrode and the negatively charged particles move toward the second electrode.

7. An evaluation method according to claim 6, wherein the voltage is an alternate voltage that alternately repeats a voltage drop and a voltage elevation that takes a shorter time than a time required in the voltage drop.

8. An evaluation method according to claim 6, wherein a portion in the first display color is specified as a portion that includes the microcapsule having a particle size smaller than the particle size of the microcapsule included in the proper portion.

9. An evaluation method according to claim 6, wherein a portion in the second display color is specified as a portion that includes the microcapsule that floats more toward the second electrode than the microcapsules included in the proper portion, or a portion that includes the microcapsule having a particle size greater than the particle size of the microcapsule included in the proper portion.

10. An evaluation method according to claim 6, wherein, prior to application of the voltage, a preliminary voltage that causes the first display color is applied between the first electrode and the second electrode.

11. An evaluation method according to claim 6, wherein the voltage is applied between the first electrode and the second electrode such that the positively charged particles move toward the second electrode, and the negatively charged particles move toward the first electrode.

12. An evaluation method according to claim 11, wherein the voltage is an alternate voltage that alternately repeats a voltage elevation and a voltage drop that takes a shorter time than a time required in the voltage elevation.

13. An evaluation method according to claim 11, wherein a portion in the second display color is specified as a portion that includes the microcapsule having a particle size smaller than the particle size of the microcapsule included in the proper portion.

14. An evaluation method according to claim 11, wherein a portion in the first display color is specified as a portion that includes the microcapsule that floats more toward the second electrode than the microcapsules included in the proper portion, or a portion that includes the microcapsule having a particle size greater than the particle size of the microcapsule included in the proper portion.

15. An evaluation method according to claim 11, wherein, prior to application of the voltage, a preliminary voltage that causes the second display color is applied between the first electrode and the second electrode.

16. An evaluation method according to claim 1, wherein the second electrode is provided to extend in a first direction as viewed in a plan view of the display layer, and the voltage is applied while moving the display layer relative to the electrode in a second direction orthogonal to the first direction.

17. An evaluation method according to claim 1, wherein the second electrode protrudes toward the display layer, and has a plurality of needle-like portions arranged in the first direction.

18. An evaluation method according to claim 1, wherein the presence of the improper portion is detected by using an imaging element.

19. A method for manufacturing a display sheet equipped with a plurality of microcapsules containing positively charged or negatively charged electrophoretic particles in a moveable manner, the method comprising:
a forming step of forming the display layer; and
an evaluation step that includes applying a voltage across a pair of first electrode and second electrode disposed opposite each other across the display layer, to apply an electric field to an examination region set in at least a portion of an area of the display layer, the voltage is applied without contacting the second electrode with the display layer.

20. A display sheet manufacturing apparatus for manufacturing a display sheet by forming a display layer on a sheet member, the display sheet manufacturing apparatus comprising:
a display layer forming device that forms the display layer on one surface side of the sheet member; and
an evaluation device that evaluates display characteristic of the display layer,
wherein the evaluation device includes: at least one electrode; a voltage application device that applies a voltage to the electrode; and a transfer device that moves a display sheet equipped with a display layer having a plurality of microcapsules containing positively charged or negatively charged electrophoretic particles in a moveable manner relative to the electrode, wherein, while moving the display layer relative to the electrode by the transfer device, a voltage is applied to the electrode by the voltage application device, thereby exerting an electric field to an examination region set in at least a portion of an area of the display layer, whereby the presence of an improper portion whose display state is improper, which is caused by at least one of a difference in particle size among the microcapsules and a difference in floating level of the microcapsules, is detected through detecting a color difference in the improper portion against a proper portion whose display state is proper.
